(19) United States
(12) Patent Application Publication
(10) Pub. No.: US 2024/0399336 A1
(43) Pub. Date: Dec. 5, 2024

(54) POLYMER-MOF-GELS AND METHODS OF MAKING SAME

(71) Applicant: UNIVERSITY OF VIRGINIA PATENT FOUNDATION, Charlottesville, VA (US)

(72) Inventors: Gaurav GIRI, Charlottesville, VA (US); Prince Kumar VERMA, Charlottesville, VA (US); Rachel A. LETTERI, Charlottesville, VA (US); Mara K. KUENEN, Charlottesville, VA (US); Mark S. BANNON, Charlottesville, VA (US)

(73) Assignee: UNIVERSITY OF VIRGINIA PATENT FOUNDATION, Charlottesville, VA (US)

(21) Appl. No.: 18/691,134

(22) PCT Filed: Sep. 16, 2022
(86) PCT No.: PCT/US2022/043814

§ 371 Date: Mar. 12, 2024

Related U.S. Application Data
(60) Provisional application No. 63/244,979, filed on Sep. 16, 2021.

(51) Int. Cl. B01J 20/22; B01J 20/28; B01J 20/32

(52) U.S. Cl. CPC B01J 20/226; B01J 20/28047; B01J 20/327; B01J 20/3272

(57) ABSTRACT

Embodiments disclosed herein provide methods of making polymer-metal organic framework-gels (polymer-MOF-gels), the method comprising forming a metal solution comprising a metal salt, an acid, and a first solvent, and forming a product mixture comprising the metal solution, a polymer, and a carboxylic acid linker to produce the polymer-MOF-gel. Embodiments disclosed herein provide polymer-MOF-gels comprising a polymer and a metal organic framework (MOF) having pores, wherein at least a portion of the polymer is entrapped in the pores of the MOF.

### CROSS-REFERENCE TO RELATED APPLICATION

This application claims the benefit of U.S. Provisional Application No. 63/244,979 filed on Sep. 16, 2021, the entire contents of which are incorporated herein by reference.

### TECHNICAL FIELD

Embodiments of the present disclosure are generally related to metal organic frameworks and polymer gels, and are more particularly related to methods of synthesizing polymer-metal organic framework-gels.

### BACKGROUND

Composite materials comprising MOFs and polymeric gels, known as polymer-metal organic framework-gels (polymer-MOF-gels), may provide advantages over MOFs and polymeric gels individually, such as compatibility with biological environments, high loading capacity, and extended-release capabilities. However, it may be challenging to form polymer-MOF-gels that realize desired characteristics such as high gel strength, high drug loading, and controlled release.

Thus, there is a need for polymer-MOF-gels and methods of making polymer-MOF-gels having improved properties.

### SUMMARY

Embodiments of the present disclosure are directed to methods of making polymer-MOF-gels comprising forming a metal solution and forming a product mixture comprising the metal solution, a polymer, and a carboxylic acid linker, which results in the formation of a polymer-MOF-gel having high gel strength, high drug loading, and controlled release.

According to at least one aspect of the present disclosure, a method of making a polymer-metal organic framework-gel (polymer-MOF-gel) includes: forming a metal solution comprising a metal salt, an acid, and a first solvent; and forming a product mixture comprising the metal solution, a polymer, and a carboxylic acid linker to produce the polymer-MOF-gel.

According to another aspect of the present disclosure, which may include any of the foregoing aspects, a MOF of the polymer-MOF-gel and the polymer-MOF-gel are formed simultaneously.

According to another aspect of the present disclosure, which may include any of the foregoing aspects, wherein the carboxylic acid linker does not contact the metal solution in the absence of the polymer.

According to another aspect of the present disclosure, which may include any of the foregoing aspects, further comprising forming a polymer mixture comprising the polymer and a second solvent before forming the product mixture, wherein the product mixture comprises the metal solution, the polymer mixture, and the carboxylic acid linker.

According to another aspect of the present disclosure, which may include any of the foregoing aspects, wherein at least a portion of the polymer of the polymer-MOF-gel is within pores of a MOF of the polymer-MOF-gel.

According to another aspect of the present disclosure, which may include any of the foregoing aspects, wherein the polymer comprises side groups, the side groups comprising polar groups, lone pair electron groups, pi-stacking groups, or combinations thereof.

According to another aspect of the present disclosure, which may include any of the foregoing aspects, wherein the polar groups comprise carboxyl groups, hydroxyl groups, amine groups, or combinations thereof.

According to another aspect of the present disclosure, which may include any of the foregoing aspects, wherein the side groups comprise from 0% to 50% of the carboxyl groups, based on a total number of the side groups.

According to another aspect of the present disclosure, which may include any of the foregoing aspects, wherein the polymer comprises polyvinyl alcohol, polyethylene glycol, polyacrylic acid, poly(acrylamide-co-acrylic acid), polystyrene, polyvinylidene fluoride, polystyrene sulfonate, poly(3,4-ethylenedioxythiophene), poly[2,5-bis(3-tetradecylthiophen-2-yl)thieno[3,2-b]thiophene], poly[2,5-bis(3-dodecylthiophen-2-yl)thieno[3,2-b]thiophene], poly[2,5-bis(3-hexadecylthiophen-2-yl)thieno[3,2-b]thiophene], poly[2,5-bis(3-octadecylthiophen-2-yl)thieno[3,2-b]thiophene], polythiophene, polytetrafluoroethylene, poly(perfluoro-3,6-dioxa-4-methyl-7-octene-sulfonic acid), or combinations thereof.

According to another aspect of the present disclosure, which may include any of the foregoing aspects, wherein the polymer comprises polyvinyl alcohol, polyethylene glycol, polyacrylic acid, poly(acrylamide-co-acrylic acid), or combinations thereof.

According to another aspect of the present disclosure, which may include any of the foregoing aspects, wherein the polymer has an average mass from 10 kilodaltons (kDa) to 500 kDa.

According to another aspect of the present disclosure, which may include any of the foregoing aspects, wherein the polymer comprises polyethylene glycol having an average mass greater than or equal to 10 kilodaltons and the product mixture comprises greater than or equal to 1 weight percent (wt %) of the polymer, based on a total weight of the product mixture.

According to another aspect of the present disclosure, which may include any of the foregoing aspects, wherein the polymer comprises poly(acrylamide-co-acrylic acid), the poly(acrylamide-co-acrylic acid) comprising a molar ratio of acrylamide to acrylic acid from 9:1: to 1:1.

According to another aspect of the present disclosure, which may include any of the foregoing aspects, wherein the product mixture comprises greater than or equal to 0.5 wt % and less than or equal to 20 wt % of the polymer, based on a total weight of the product mixture.

According to another aspect of the present disclosure, which may include any of the foregoing aspects, wherein the metal salt is selected from the group consisting of a zirconium salt, a zinc salt, a copper salt, an aluminum salt, an iron salt, a titanium salt, a magnesium salt, a hafnium salt, a cobalt salt, and combinations thereof.

According to another aspect of the present disclosure, which may include any of the foregoing aspects, wherein the carboxylic acid linker is selected from the group consisting of terephthalic acid, 2-hydroxyterephthalic acid, 2,5-dihydroxyterephthalic acid, 2-aminoterephthalic acid, 2,5-diaminoterephthalic acid, 2-sulfoterephthalic acid, 2,5-disulfoterephthalic acid, 2-methylterephthalic acid, 2,5-methylterephthalic acid, 2-phosphonoterephtahlic acid, 2,5-diphosphonoterephthalic acid, cyclohexane-1,2,4-tricarboxylic acid, 1,2,4,5-benzenetetracarboxylic acid, cyclohexane-1,2,4,5-tetracarboxylic acid, fumaric acid, 1,4-naphthalenedicarboxylic acid, biphenyl-4,4′-dicarboxylic acid, 2-amino-4,4′-biphenyldicarboxylic acid, 2-sulfo-4,4′-biphenyldicarboxylic acid, 1,3,5-benzenetriacetic acid (“trimesic acid”), 1,3,5-cyclohexanetricarboxylic acid, 2-methylimidazole, benzimidazole, 1,3,5-benzenetrisulfonic acid, 1,4-benzenedisulfonic acid, tetraethyl 4,4′,4″,4′″-(pyrene-1,3,6,8-tetrayl)tetrabenzoic acid, 1,3,6,8-tetrakis-(p-benzoic acid)pyrene, 4,4′,4″-(triazine-2,4,6-triyl-tris(benzene-4,1-diyl))tribenzoic acid, 4,4′,4″-(benzene-1,3,5-triyl-tris(benzene-4, 1-diyl))tribenzoic acid, 4,4′,4″,4′″-(Porphine-5,10,15,20-tetrayl)tetrakis(benzoic acid), and combinations thereof.

According to another aspect of the present disclosure, which may include any of the foregoing aspects, wherein the carboxylic acid linker is selected from the group consisting of terephthalic acid, 2-aminoterephthalic acid, 1,3,6,8-tetrakis-(p-benzoic acid)pyrene, biphenyl-4,4′-dicarboxylic acid, 4,4′,4″,4′″-(Porphine-5,10,15,20-tetrayl)tetrakis(benzoic acid), and combinations thereof.

According to another aspect of the present disclosure, which may include any of the foregoing aspects, a method of forming a polymer-MOF-hydrogel, the method comprising contacting the polymer-MOF-gel of any one of the foregoing aspects with water.

According to another aspect of the present disclosure, which may include any of the foregoing aspects, wherein contacting the polymer-MOF-gel with water includes dialyzing the polymer-MOF-gel to form the polymer-MOF hydrogel.

According to another aspect of the present disclosure, which may include any of the foregoing aspects, further comprising contacting the polymer-MOF hydrogel with a solution comprising one or more drug compounds, thereby loading at least a portion of the one or more drug compounds in the polymer-MOF hydrogel.

According to another aspect of the present disclosure, which may include any of the foregoing aspects, a polymer-metal organic framework-gel (polymer-MOF-gel), the polymer-MOF-gel comprising a polymer and a metal organic framework (MOF) having pores, wherein at least a portion of the polymer is entrapped in the pores of the MOF.

According to another aspect of the present disclosure, which may include any of the foregoing aspects, wherein the polymer comprises side groups, the side groups comprising polar groups, carboxyl groups, lone pair electron groups, pi-stacking groups, or combinations thereof.

According to another aspect of the present disclosure, which may include any of the foregoing aspects, wherein the polar groups comprise carboxyl groups, hydroxyl groups, amine groups, or combinations thereof.

According to another aspect of the present disclosure, which may include any of the foregoing aspects, wherein the side groups comprise from 0% to 50% of the carboxyl groups, based on a total number of the side groups.

According to another aspect of the present disclosure, which may include any of the foregoing aspects, wherein the polymer has an average mass from 10 kilodaltons (kDa) to 500 kDa.

According to another aspect of the present disclosure, which may include any of the foregoing aspects, wherein the polymer-MOF-gel comprises polyvinyl alcohol, polyethylene glycol, polyacrylic acid, poly(acrylamide-co-acrylic acid), polystyrene, polyvinylidene fluoride, polystyrene sulfonate, poly(3,4-ethylenedioxythiophene), poly[2,5-bis(3-tetradecylthiophen-2-yl)thieno[3,2-b]thiophene], poly[2,5-bis(3-dodecylthiophen-2-yl)thieno[3,2-b]thiophene], poly[2,5-bis(3-hexadecylthiophen-2-yl)thieno[3,2-b]thiophene], poly[2,5-bis(3-octadecylthiophen-2-yl)thieno[3,2-b]thiophene], polythiophene, polytetrafluoroethylene, poly(perfluoro-3,6-dioxa-4-methyl-7-octene-sulfonic acid), or combinations thereof.

According to another aspect of the present disclosure, which may include any of the foregoing aspects, wherein the polymer-MOF-gel has a shear storage modulus (G′) that is greater than a shear loss modulus (G″), as measured at an angular frequency from 0 radians per second (rad/s) to 10 rad/s.

According to another aspect of the present disclosure, which may include any of the foregoing aspects, wherein the shear storage modulus is at least 5 times greater than the shear loss modulus, as measured at an angular frequency of from 0 rad/s to 10 rad/s.

According to another aspect of the present disclosure, which may include any of the foregoing aspects, wherein the MOF is selected from the group consisting of UiO-66, UiO-66 (NH₂), UiO-67, NU-901, MOF-525, and combinations thereof.

According to another aspect of the present disclosure, which may include any of the foregoing aspects, further comprising one or more drug compounds, wherein the one or more drug compounds are released from the polymer-MOF-gel.

According to another aspect of the present disclosure, which may include any of the foregoing aspects, wherein the polymer-MOF-gel comprises greater than or equal to 2 wt % of the one or more drug compounds, based on a total weight of the polymer-MOF-gel when dried.

According to another aspect of the present disclosure, which may include any of the foregoing aspects, wherein the polymer-MOF-gel is a polymer-MOF hydrogel.

According to another aspect of the present disclosure, which may include any of the foregoing aspects, the zinc salt comprises Zn(NO₃)₂, ZnCl₂, ZnBr₂, ZnI₂, Zn(ClO₄)₂, ZnSO₄, Zn₃(PO₄)₂, Zn(CH₃COO), Zn₃(C₆H₅O₇)₂ (“Zinc citrate”), Zn(CH₂C(CH₃)CO₂)₂ (“Zinc methacrylate”), Zn(CH₂CHCO₂)₂ (“Zinc acrylate”), Zn(OCH₂CH₂CH₃)₂ (“Zinc propoxide”), or combinations thereof.

According to another aspect of the present disclosure, which may include any of the foregoing aspects, the copper salt comprises Cu(NO₃)₂, CuCl, CuCl₂, CuBr, CuBr₂, Cu₂, CuI₂, Cu(ClO₄)₂, CuSO₄, Cu₃(PO₄)₂ Cu(CH₃COO), Cu₃(C₆H₅O₇)₂ (“Copper citrate”), Cu(CH₂C(CH₃)CO₂)₂ (“Copper methacrylate”), Cu(CH₂CHCO₂)₂ (“Copper acrylate”), Cu((CH₃)₂CHO)₂ (“Copper propoxide”), or combinations thereof.

According to another aspect of the present disclosure, which may include any of the foregoing aspects, the aluminum salt comprises AlCl₃, AlBr₃, AlI₃, Al(NO₃)₃, Al(ClO₄)₃, Al₂(SO₄)₃, AlPO₄, Al(CH₃COO)₃, Al(C₆H₅O₇) (“Aluminum citrate”), Al(CH₂C(CH₃)CO₂)₃ (“Aluminum methacrylate”), Al(CH₂CHCO₂)₃ (“Aluminum acrylate”), Al((CH₃)₂CHO)₃ (“Aluminum propoxide”), or combinations thereof.

According to another aspect of the present disclosure, which may include any of the foregoing aspects, the iron salt comprises FeCl₂, FeCl₃, FeBr₃, FeI₂, Fe(NO₃)2, FeSO₄, Fe₂(SO₄)₃, FePO₄, Fe(ClO₄)₂, Fe(CH₃COO)₂, Fe(C₆H₅O₇) (“Iron citrate”), Fe(CH₂C(CH₃)CO₂)₃ (“Iron methacrylate”), Fe(CH₂CHCO₂)₃ (“Iron acrylate”), Fe((CH₃)₂CHO)₃ (“Iron propoxide”), or combinations thereof.

According to another aspect of the present disclosure, which may include any of the foregoing aspects, the titanium salt comprises TiCl₂, TiCl₃, TiCl₄, TiBr₄, TiI₄Ti(NO₃)₄, Ti(ClO₄)₄, Ti(SO₄)₂, Ti₃(PO₄)₄, Ti(CH₃COO)₄, Ti(C₆H₅O₇) (“Titanium citrate”), Ti(CH₂C(CH₃)CO₂)₄ (“Titanium methacrylate”), Ti(CH₂CHCO₂)₄ (“Titanium acrylate”), Ti((CH₃)₂CHO)₄ (“Titanium propoxide”), or combinations thereof.

According to another aspect of the present disclosure, which may include any of the foregoing aspects, the magnesium salt comprises MgCl₂, MgBr₂, MgI₂, Mg(NO₃)₂, Mg(SO₄), Mg(PO₄)₂, Mg(ClO₄)₂, Mg(CH₃COO)₂, Mg(C₆H₅O₇) (“Magnesium citrate”), Mg(CH₂C(CH₃)CO₂)₂ (“Magnesium methacrylate”), Mg(CH₂CHCO₂)₂ (“Magnesium acrylate”), Mg((CH₃)₂CHO)₂ (“Magnesium propoxide”), or combinations thereof.

According to another aspect of the present disclosure, which may include any of the foregoing aspects, the hafnium salt comprises at least one of HfCl₄, HfBr₄, HfI₄, Hf(NO₃)₄, Hf(SO₄)₂, Hf₃(PO₄)₄, Hf(CH₃COO)₄, Hf(C₆H₅O₇) (“Hafnium citrate”), Hf(CH₂C(CH₃)CO₂)₄ (“Hafnium methacrylate”), Hf(CH₂CHCO₂)₄ (“Hafnium acrylate”), Hf(CH₃)₂CHO)₄ (“Hafnium propoxide”), or combinations thereof.

According to another aspect of the present disclosure, which may include any of the foregoing aspects, the cobalt salt comprises CoCl₂, CoCl₃, CoBr₂, CoI₂, Co(NO₃)₂, Co(ClO₄)₂, Co(SO₄), Co(CH₃COO), Co(CH₂C(CH₃)CO₂)₂ (“Cobalt methacrylate”), Co(CH₂CHCO₂)₂ (“Cobalt acrylate”), and Co((CH₃)₂CHO)₂ (“Cobalt propoxide”), or combinations thereof.

Additional features and advantages of the described embodiments will be set forth in the detailed description that follows. The additional features and advantages of the described embodiments will be, in part, readily apparent to those skilled in the art from that description or recognized by practicing the described embodiments, including the detailed description that follows as well as the drawings and the claims.

### BRIEF SUMMARY OF THE DRAWINGS

FIG. 1 is a method flow diagram, according to one or more embodiments shown and described herein;

FIG. 2 is an X-ray diffraction plot of an exemplary PVA-UiO-66-gel and a comparative example, according to one or more embodiments shown and described herein;

FIG. 3A is a transmission electron micrograph of an exemplary PVA-UiO-66-gel, according to one or more embodiments shown and described herein;

FIG. 3B is a transmission electron micrograph of a comparative PVA-Zr-oxo-gel;

FIG. 3C is a transmission electron micrograph of a comparative PVA-UiO-66 physical mixture;

FIG. 3D is a scanning electron micrograph of any exemplary PVA-UiO-66-gel, according to one or more embodiments shown and described herein;

FIG. 3E is a scanning electron micrograph of a comparative PVA-Zr-oxo-gel;

FIG. 3F is a scanning electron micrograph of a comparative PVA-UiO-66 physical mixture;

FIG. 4 is a nitrogen adsorption and desorption plot of an exemplary PVA-UiO-66-gel and a comparative PVA-Zr-oxo-gel, according to one or more embodiments described herein;

FIG. 5 is an X-ray diffraction plot of an exemplary PEG-UiO-66-gel and a comparative example, according to one or more embodiments shown and described herein;

FIG. 6 is an X-ray diffraction plot of an exemplary PAA-UiO-66-gel and a comparative example, according to one or more embodiments shown and described herein;

FIG. 7 is an X-ray diffraction plot of an exemplary PAAA-UiO-66-gel and a comparative example, according to one or more embodiments shown and described herein;

FIG. 8 is an oscillatory shear rheology plot of an exemplary 2 wt. % PVA-UiO-66-gel and a comparative example, according to one or more embodiments shown and described herein;

FIG. 9 is an oscillatory shear rheology plot of an exemplary 3 wt. % PVA-UiO-66-gel and a comparative example, according to one or more embodiments shown and described herein;

FIG. 10A is an X-ray diffraction plot of an exemplary PEG-UiO-66-NH₂-gel made in accordance with embodiments described herein;

FIG. 10B is an X-ray diffraction plot of an exemplary PEG-UiO-67-gel, according to one or more embodiments shown and described herein;

FIG. 10C is an X-ray diffraction plot of an exemplary PEG-NU-901-gel, according to one or more embodiments shown and described herein;

FIG. 10D is an X-ray diffraction plot of an exemplary PEG-MOF-525-gel, according to one or more embodiments shown and described herein;

FIG. 11A is a scanning electron micrograph of an exemplary PVA-UiO-66-NH₂-gel, according to one or more embodiments shown and described herein;

FIG. 11B is a scanning electron micrograph of an exemplary PVA-NU-901-gel, according to one or more embodiments shown and described herein;

FIG. 11C is a scanning electron micrograph of an exemplary PVA-UiO-67-gel, according to one or more embodiments shown and described herein;

FIG. 11D is a scanning electron micrograph of an exemplary PVA-MOF-525-gel, according to one or more embodiments shown and described herein;

FIG. 12 is an oscillatory shear rheology plot of an exemplary PVA-UiO-66-hydrogel and an exemplary PVA-UiO-66-gel, according to one or more embodiments shown and described herein;

FIG. 13 is a thermogravimetric analysis data plot of an exemplary PVA-UiO-66-hydrogel, an exemplary PVA-UiO-66-gel, and a comparative examples, according to one or more embodiments shown and described herein;

FIG. 14A is a methylene blue loading graph of an exemplary PVA-UiO-66-hydrogel and comparative examples, according to one or more embodiments shown and described herein;

FIG. 14B is a methylene blue loading graph of an exemplary PVA-UiO-66-hydrogel, an exemplary PVA-UiO-66-NH₂-hydrogel, an exemplary PVA-NU-901-hydrogel, an exemplary PVA-UiO-67-hydrogel, an exemplary PVA-MOF-525-hydrogel, and a comparative example, according to one or more embodiments shown and described herein;

FIG. 15 is a methylene blue release plot of an exemplary PVA-UiO-66-hydrogel and comparative examples, according to one or more embodiments shown and described herein;

FIG. 16 is a methylene blue release graph of an exemplary PVA-UiO-66-hydrogel and comparative examples, according to one or more embodiments shown and described herein; and

FIG. 17 is an Angiotensin 1-7 loading graph of an exemplary PVA-UiO-66-hydrogel and comparative examples, according to one or more embodiments shown and described herein.

### DETAILED DESCRIPTION

Specific embodiments of the present application will now be described. The disclosure may, however, be embodied in different forms and should not be construed as limited to the embodiments set forth in this disclosure. Rather, these embodiments are provided so that this disclosure will be thorough and complete, and will fully convey the scope of the subject matter to those skilled in the art.

As used in this disclosure, a “polymer-metal organic framework-gel” or “polymer-MOF-gel refers to a composition including a polymer and a MOF, wherein the composition comprises a gel, as determined by the gel inversion test, as described herein.

Metal organic frameworks (MOFs), where organic linkers bridge inorganic metal clusters, exhibit high specific surface area, high loading capacities for a range of molecules, and tunable porosity, making them useful in a wide range of applications including catalysis, gas storage, and sensing. MOFs may also be used for drug delivery applications, by enabling loading and release of therapeutics. However, MOFs generally present difficulties as they are not easily dispersed in aqueous media and are prone to aggregation. Such difficulty limits their use in biomedical applications. Polymeric gels, dimensional networks of cross-linked, swollen polymer chains, may serve as depots for delivery of small molecules and biological therapeutics, such as peptides and proteins. However, due to their relatively high porosity, polymeric gels may be difficult to use in controlled release medical applications.

Composite materials comprising MOFs and polymeric gels, known as polymer-metal organic framework-gels (polymer-MOF-gels), may provide advantages over MOFs and polymeric gels individually. The polymeric gels may provide compatibility with biological environments, while the MOFs may provide high loading capacity and extended-release capabilities. However, it may be challenging to form polymer-MOF-gels that realize desired characteristics such as high gel strength, high drug loading, and controlled release.

Disclosed herein are methods of making polymer-MOF-gels, which mitigate the aforementioned problems. In particular, the methods of making polymer-MOF-gels disclosed herein involve simultaneous formation of the gel and MOF and utilize a given amount of a polymer with a certain side chain chemistry and length (i.e., average mass of polymer), which results in the formation of a polymer-MOF-gel having high gel strength, high drug loading, and controlled release. While not wishing to be bound by theory, it is believed that these improved properties are the result of at least a portion of the polymer being entrapped in pores of the MOF in the polymer-MOF-gels. Polymer-MOF-gels described in this disclosure may be utilized for applications such as drug delivery, among others.

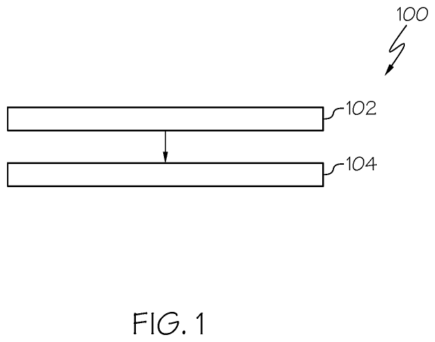

Turning now to FIG. 1, a method 100 of making a polymer-MOF-gel composition is depicted. As depicted, FIG. 1 includes a series of “blocks” which are each representative of one or more steps in the processes presently described. The process of FIG. 1 generally includes forming a metal solution (at block 102), and forming a product mixture comprising the metal solution, a polymer, and a carboxylic acid linker to produce the polymer-MOF-gel (at block 104).

As described herein, at block 102, the method may include forming a metal solution comprising a metal salt, an acid, and a first solvent.

In embodiments, the metal salt may comprise a zirconium salt, a zinc salt, a copper salt, an aluminum salt, an iron salt, a titanium salt, a magnesium salt, a hafnium salt, a cobalt salt, or combinations thereof. In embodiments, the metal salt may be selected from the group consisting of a zirconium salt, a zinc salt, a copper salt, an aluminum salt, an iron salt, a titanium salt, a magnesium salt, a hafnium salt, a cobalt salt, and combinations thereof.

In embodiments, the zirconium salt may comprise ZrOCl₂, ZrCl₄, ZrBr₄, ZrI₄, ZrO(NO₃)₂, Zr(ClO₄)₄ Zr(SO₄)₂, Zr(PO₄)₄ ZrO(CH₃COO)₂, Zr(C₆H₅O₇) (“Zirconium citrate”), Zr(CH₂C(CH₃)CO₂)₄ (“Zirconium methacrylate”), Zr(CH₂CHCO₂)₄ (“Zirconium acrylate”), Zr(OC₄H₉)₄ (“Zirconium tertbutoxide”), Zr(OCH₂CH₂CH₃)₄ (“Zirconium (N) propoxide”), Zr₆O₄(OH)₄(CH₂C(CH₃)CO₂)₁₂ (“Zirconium(IV) oxo hydroxy methacrylate”), or combinations thereof.

In embodiments, the zinc salt may comprise Zn(NO₃)₂, ZnCl₂, ZnBr₂, ZnI₂, Zn(ClO₄)₂, ZnSO₄, Zn₃(PO₄)₂, Zn(CH₃COO), Zn₃(C₆H₅O₇)₂ (“Zinc citrate”), Zn(CH₂C(CH₃)CO₂)₂ (“Zinc methacrylate”), Zn(CH₂CHCO₂)₂ (“Zinc acrylate”), Zn(OCH₂CH₂CH₃)₂ (“Zinc propoxide”), or combinations thereof.

In embodiments, the copper salt may comprise Cu(NO₃)₂, CuCl, CuCl₂, CuBr, CuBr₂, CuI, CuI₂, Cu(ClO₄)₂, CuSO₄, Cu₃(PO₄)₂ Cu(CH₃COO), Cu₃(C₆H₅O₇)₂ (“Copper citrate”), Cu(CH₂C(CH₃)CO₂)₂ (“Copper methacrylate”), Cu(CH₂CHCO₂)₂ (“Copper acrylate”), Cu((CH₃)₂CHO)₂ (“Copper propoxide”), or combinations thereof.

In embodiments, the aluminum salt may comprise AlCl₃, AlBr₃, AlI₃, Al(NO₃)₃, Al(ClO₄)₃, Al₂(SO₄)₃, AlPO₄, Al(CH₃COO)₃, Al(C₆H₅O₇) (“Aluminum citrate”), Al(CH₂C(CH₃)CO₂)₃ (“Aluminum methacrylate”), Al(CH₂CHCO₂)₃ (“Aluminum acrylate”), Al((CH₃)₂CHO)₃ (“Aluminum propoxide”), or combinations thereof.

In embodiments, the iron salt may comprise FeCl₂, FeCl₃, FeBr₃, FeI₂, Fe(NO₃)₂, FeSO₄, Fe₂(SO₄)₃, FePO₄, Fe(ClO₄)₂, Fe(CH₃COO)₂, Fe(C₆H₅O₇) (“Iron citrate”), Fe(CH₂C(CH₃)CO₂)₃ (“Iron methacrylate”), Fe(CH₂CHCO₂)₃ (“Iron acrylate”), Fe((CH₃)₂CHO)₃ (“Iron propoxide”), or combinations thereof.

In embodiments, the titanium salt may comprise TiCl₂, TiCl₃, TiCl₄, TiBr₄, TiI₄ Ti(NO₃)₄, Ti(ClO₄)₄, Ti(SO₄)₂, Ti₃(PO₄)₄, Ti(CH₃COO)₄, Ti(C₆H₅O₇) (“Titanium citrate”), Ti(CH₂C(CH₃)CO₂)₄ (“Titanium methacrylate”), Ti(CH₂CHCO₂)₄ (“Titanium acrylate”), Ti((CH₃)₂CHO)₄ (“Titanium propoxide”), or combinations thereof.

In embodiments, the magnesium salt may comprise MgCl₂, MgBr₂, MgI₂, Mg(NO₃)₂, Mg(SO₄), Mg(PO₄)₂, Mg(ClO₄)₂, Mg(CH₃COO)₂, Mg(C₆H₅O₇) (“Magnesium citrate”), Mg(CH₂C(CH₃)CO₂)₂ (“Magnesium methacrylate”), Mg(CH₂CHCO₂)₂ (“Magnesium acrylate”), Mg((CH₃)₂CHO)₂ (“Magnesium propoxide”), or combinations thereof.

In embodiments, the hafnium salt may comprise HfCl₄, HfBr₄, HfI₄, Hf(NO₃)₄, Hf(SO₄)₂, Hf₃(PO₄)₄, Hf(CH₃COO)₄, Hf(C₆H₅O₇) (“Hafnium citrate”), Hf(CH₂C(CH₃)CO₂)₄ (“Hafnium methacrylate”), Hf(CH₂CHCO₂)₄ (“Hafnium acrylate”), Hf(CH₃)₂CHO)₄ (“Hafnium propoxide”), or combinations thereof.

In embodiments, the cobalt salt may comprise CoCl₂, COCl₃, CoBr₂, CoI₂, Co(NO₃)₂, Co(ClO₄)₂, Co(SO₄), Co(CH₃COO), Co(CH₂C(CH₃)CO₂)₂ (“Cobalt methacrylate”), Co(CH₂CHCO₂)₂ (“Cobalt acrylate”), and Co((CH₃)₂CHO)₂ (“Cobalt propoxide”), or combinations thereof.

In embodiments, the acid may comprise a weak organic acid. The weak organic acid may be one or more monocarboxylic acids. Exemplary monocarboxylic acids include, but are not limited to, glycine, benzoic acid, methacrylic acid, formic acid, acetic acid, propionic acid, butyric acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, icosanoic acid, and mixtures thereof. Additional exemplary organic acids include fluoroacetic acid, difluoroacetic acid, trifluoroacetic acid, acrylic acid, or combinations thereof.

In embodiments, the first solvent may comprise water, one or more polar aprotic solvents, such as N,N-Dimethylformamide (“DMF”), Dimethyl sulfoxide (“DMSO”), acetone, and acetonitrile, and/or one or more polar solvents, such as dichloromethane (“DCM”), tetrahydrofuran (“THF”), and ethyl acetate, or combinations thereof. In embodiments, the first solvent may comprise non-polar solvents such as pentane, hexane, cyclohexane, benzene, toluene, chloroform, and diethyl ether, as well as polar protic solvents, such as ammonia, alcohols, and acetic acid, or combinations thereof.

In embodiments, the metal solution may be formed by combining at least the metal salt, the acid, and the first solvent in any combination. For instance, in embodiments, the metal salt and the acid may first be mixed to form a first mixture, and the first mixture may be mixed with the first solvent to form the metal solution.

In embodiments, the metal solution may be further treated before being used to form the product mixture. For instance, in embodiments the metal solution may be sonicated and/or heated to a temperature above room temperature and then allowed to cool to room temperature. Such sonication and/or heating may encourage a higher amount of the metal salt to dissolve in the metal solution. Without wishing to be bound by theory, it is believed a MOF intermediate compound, which may be referred to as a metal-oxo cluster compound, may form after preparing the metal solution.

As described herein, the method 100 continues at block 104 with forming a product mixture comprising the metal solution, a polymer, and a carboxylic acid linker to produce the polymer-MOF-gel. In embodiments, the polymer-MOF-gel may be formed by simultaneous formation of the MOF and gelation of the product mixture, resulting in at least a portion of polymer being entrapped in the MOF. This method differs from conventional methods that first form a MOF and then combine the MOF with a polymer. In embodiments, the polymer-MOF-gel, formed by the methods described herein, may have improved properties such as increased gel strength, increased drug loading, and controlled release, in comparison to conventional methods that do not include the polymer entrapped in the MOF.

In embodiments, the polymer may be mixed with a second solvent to form a polymer mixture before introducing the polymer to the metal solution. In such embodiments, the product mixture may comprise the metal solution the polymer mixture, and the carboxylic acid linker. In embodiments, the polymer may be in a melt state and the polymer may be mixed with the metal solution before introducing the carboxylic acid linker.

In embodiments, the carboxylic acid linker may not contact the metal solution in the absence of the polymer. In embodiments, the carboxylic acid linker may be combined with the polymer to form a polymer linker mixture, and the polymer linker mixture may be mixed with the metal solution to form the product mixture. In other embodiments, the metal solution and polymer may be mixed to form a precursor mixture, and the carboxylic acid linker may be added to the precursor mixture to form the product mixture. While not wishing to be bound by theory, it is believed that combining the metal solution and carboxylic acid linker in the absence of the polymer may result in formation of the MOF, without entrapping the polymer in the pores of the MOF, which may not result in a polymer-MOF-gel or may result in a polymer-MOF-gel with inferior properties, such as decreased gel strength or decreased drug loading capacity.

To ensure formation of a polymer-MOF-gel having high gel strength, high drug loading, and controlled release, the polymer is included in a given amount with a certain side chain chemistry and length (i.e., average mass), as described herein.

In embodiments, the polymer may comprise side groups. The side groups may include polar groups, lone pair electron groups, pi-stacking groups, or combinations thereof. As used herein, “side group” refers to a pendant group extending from the backbone chain of the polymer. While not wishing to be bound by theory, it is believed that the side group chemistry of the polymer plays an important role in the formation of the polymer-MOF-gel, as described herein.

In embodiments, the polar groups may comprise carboxyl groups, hydroxyl groups, amine groups, or combinations thereof. As used herein, a “polar group” refers to a group of atoms having polar bonds, where polar bonds are defined as a difference in electronegativity between the two atoms of at least 0.45. As used herein, a “carboxyl group” refers to a chemical group comprising a carbon atom double bonded to an oxygen atom and singly bonded to a hydroxyl group. An exemplary polymer comprising a carboxyl group is polyacrylic acid. As used herein, a “hydroxyl group” refers to a chemical group comprising a carbon atom singly bonded to one oxygen atom covalently bonded to one hydrogen atom. An exemplary polymer comprising a hydroxyl group is polyvinyl alcohol. As used herein, an “amine group” refers to a chemical group attached to a hydrocarbon or similar comprising one nitrogen atom covalently bonded to one or two hydrogen atoms. An exemplary polymer comprising an amine group is poly(2-aminoethyl methacrylate). In embodiments, the side groups may comprise from 0% to 50% of the carboxyl groups, based on a total number of the side groups. For instance, the side groups may comprise from 0% to 50%, from 0% to 40%, from 0% to 30%, from 0% to 20%, from 0% to 10%, from 10% to 50%, from 10% to 40%, from 10% to 30%, from 10% to 20%, from 20% to 50%, from 20% to 40%, from 20% to 30%, from 30% to 50%, or from 40% to 50% of the carboxyl groups. While not wishing to be bound by theory, it is believed that utilizing a polymer having greater than 50% of the carboxyl groups may result in the polymer-MOF-gel not forming. Specifically, the carboxyl groups may form coordination bonds with a metal cluster MOF intermediate, inhibiting formation of the MOF, while still inducing gelation. That is, the carboxyl groups may competitively bind with the metal cluster MOF intermediate, disrupting bonding between the metal cluster MOF intermediate and the carboxylic acid linker. Furthermore, reducing the amount of carboxyl groups that make up the side groups of the polymer, such as less than 50% of the carboxyl groups, may result in the formation of the polymer-MOF-gel.

In embodiments, the side groups may comprise from 0% to 100% of the hydroxyl groups, based on a total number of the side groups. For instance, the side groups may comprise from 0% to 90%, from 0% to 80%, from 0% to 70%, from 0% to 60%, from 0% to 50%, from 0% to 40%, from 0% to 30%, from 0% to 20%, from 0% to 10%, from 20% to 100%, from 20% to 90%, from 20% to 80%, from 20% to 70%, from 20% to 60%, from 20% to 50%, from 20/s to 40%, from 20% to 30%, from 40% to 100%, from 40% to 90%, from 40% to 80%, from 40% to 70%, from 40% to 60%, from 40% to 50%, from 60% to 100%, from 60% to 90%, from 60% to 80%, or from 60% to 70% of the hydroxyl groups. While not wishing to be bound by theory, it is believed that the hydroxyl groups may form hydrogen bonds with a metal cluster MOF intermediate, thereby not significantly interfering with the formation of the MOF, which may result in the formation of the polymer-MOF gel.

In embodiments, the side groups may comprise from 0% to 100% of the amine groups, based on a total number of the side groups. For instance, the side groups may comprise from 0% to 90%, from 0% to 80%, from 0% to 70%, from 0% to 60%, from 0% to 50%, from 0% to 40%, from 0% to 30%, from 0% to 20%, from 0% to 10%, from 20% to 100%, from 20% to 90%, from 20% to 80%, from 20% to 70%, from 20% to 60%, from 20% to 50%, from 20% to 40%, from 20% to 30%, from 40% to 100%, from 40% to 90%, from 40% to 80%, from 40% to 70%, from 40% to 60%, from 40% to 50%, from 60% to 100%, from 60% to 90%, from 60% to 80%, or from 60% to 70% of the amine groups. While not wishing to be bound by theory, it is believed that the amine groups may form hydrogen bonds with a metal cluster MOF intermediate, thereby not significantly interfering with the formation of the MOF, which may result in the formation of the polymer-MOF gel.

In embodiments, the side groups may comprise lone pair electron groups that donate electron density into metal clusters. As used herein, a “lone pair electron group” refers to a chemical group having at least a pair of valence electrons that are not shared with another atom in a covalent bond. An exemplary polymer comprising a lone pair electron group can include, but not be limited to, polyethylene glycol.

In embodiments, the side groups may comprise pi-stacking groups. As used herein, a “pi-stacking group” refers to a chemical group having an attractive, noncovalent interaction between the pi bonds of aromatic rings. An exemplary polymer comprising a pi-stacking group can include, but not be limited to polystyrene.

The chain length of the polymer is correlated to the average mass of the polymer. A greater average mass means a greater average chain length. In embodiments, the polymer may have an average mass, equivalent to the weight average molecular weight of the polymer, from 10 kilodaltons (kDa) to 500 kDa. For instance, the polymer may have an average mass from 10 kDa to 400 kDa, from 10 kDa to 300 kDa, from 10 kDa to 200 kDa, from 15 kDa to 500 kDa, from 15 kDa to 400 kDa, from 15 kDa to 300 kDa, from 15 kDa to 200 kDa, from 20 kDa to 500 kDa, from 20 kDa to 400 kDa, from 20 kDa to 300 kDa, from 20 kDa to 200 kDa, from 30 kDa to 400 kDa, from 30 kDa to 400 kDa, from 30 kDa to 300 kDa, from 30 kDa to 200 kDa, from 35 kDa to 500 kDa, from 35 kDa to 400 kDa, from 35 kDa to 300 kDa, from 35 kDa to 200 kDa, from 40 kDa to 500 kDa, from 40 kDa to 400 kDa, from 40 kDa to 300 kDa, from 40 kDa to 200 kDa, from 50 kDa to 500 kDa, from 50 kDa to 400 kDa, from 50 kDa to 300 kDa, from 50 kDa to 200 kDa, from 60 kDa to 500 kDa, from 60 kDa to 400 kDa, from 60 kDa to 300 kDa, from 60 kDa to 200 kDa, from 70 kDa to 500 kDa, from 70 kDa to 400 kDa, from 70 kDa to 300 kDa, from 70 kDa to 200 kDa, from 80 kDa to 500 kDa, from 80 kDa to 400 kDa, from 80 kDa to 300 kDa, from 80 kDa to 200 kDa, from 90 kDa to 500 kDa, from 90 kDa to 400 kDa, from 90 kDa to 300 kDa, from 90 kDa to 200 kDa, from 100 kDa to 500 kDa, from 100 kDa to 400 kDa, from 100 kDa to 300 kDa, or from 100 kDa to 200 kDa. While not wishing to be bound by theory, it is believed that selection of a polymer have a smaller average mass, such as less than 10 kDa, in the methods described herein may not induce gelation.

In embodiments where the polymer is mixed with a second solvent to form the polymer mixture, the polymer mixture may comprise from 0.5 weight percent (wt. %) to 90 wt. % of the polymer, based on the total weight of the polymer mixture. For instance, the polymer mixture may comprise from 0.5 wt. % to 80 wt. %, from 0.5 wt. % to 70 wt. %, from 0.5 wt. % to 60 wt. %, from 0.5 wt. % to 50 wt. %, from 0.5 wt. % to 40 wt. %, from 0.5 wt. % to 30 wt. %, from 0.5 wt. % to 20 wt. %, from 0.5 wt. % to 15 wt. %, from 0.5 wt. % to 10 wt. %, from 0.5 wt. % to 5 wt. %, from 1 wt. % to 90 wt. %, from 1 wt. % to 80 wt. %, from 1 wt. % to 70 wt. %, from 1 wt. % to 60 wt. %, from 1 wt. % to 50 wt. %, from 1 wt. % to 40 wt. %, from 1 wt. % to 30 wt. %, from 1 wt. % to 20 wt. %, from 1 wt. % to 15 wt. %, from 1 wt. % to 10 wt. %, from 1 wt. % to 5 wt. %, from 2 wt. % to 90 wt. %, from 2 wt. % to 80 wt. %, from 2 wt. % to 70 wt. %, from 2 wt. % to 60 wt. %, from 2 wt. % to 50 wt. %, from 2 wt. % to 40 wt. %, from 2 wt. % to 30 wt. %, from 2 wt. % to 20 wt. %, from 2 wt. % to 15 wt. %, from 2 wt. % to 10 wt. %, from 2 wt. % to 5 wt. %, from 5 wt. % to 90 wt. %, from 5 wt. % to 80 wt. %, from 5 wt. % to 70 wt. %, from 5 wt. % to 60 wt. %, from 5 wt. % to 50 wt. %, from 5 wt. % to 40 wt. %, from 5 wt. % to 30 wt. %, from 5 wt. % to 20 wt. %, from 5 wt. % to 15 wt. %, from 5 wt. % to 10 wt. %, from 10 wt. % to 90 wt. %, from 10 wt. % to 80 wt. %, from 10 wt. % to 70 wt. %, from 10 wt. % to 60 wt. %, from 10 wt. % to 50 wt. %, from 10 wt. % to 40 wt. %, from 10 wt. % to 30 wt. %, from 10 wt. % to 20 wt. %, from 10 wt. % to 15 wt. %, from 20 wt. % to 90 wt. %, from 20 wt. % to 80 wt. %, from 20 wt. % to 70 wt. %, from 20 wt. % to 60 wt. %, from 20 wt. % to 50 wt. %, from 20 wt. % to 40 wt. %, from 20 wt. % to 30 wt. %, from 30 wt. % to 90 wt. %, from 30 wt. % to 80 wt. %, from 30 wt. % to 70 wt. %, from 30 wt. % to 60 wt. %, from 30 wt. % to 50 wt. %, from 30 wt. % to 40 wt. %, from 40 wt. % to 90 wt. %, from 40 wt. % to 80 wt. %, from 40 wt. % to 70 wt. %, from 40 wt. % to 60 wt. %, from 40 wt. % to 50 wt. % of the polymer, based on the total weight of the polymer mixture.

While not wishing to be bound by theory, it is believed that both the chain length (i.e., average mass) of the polymer and the amount of the polymer in the polymer mixture play a role in gelation of the polymer-MOF-gel. An increased average mass of the polymer and an increased amount of polymer may increase the likelihood of bridging a greater number of MOF particles, thereby inducing gelation. In some embodiments, a polymer having a lower average mass may be used to induce gel formation by including a greater amount of the polymer.

In embodiments, the polymer may comprise at least one of polyvinyl alcohol, polyethylene glycol, polyacrylic acid, poly(acrylamide-co-acrylic acid), polystyrene, polyvinylidene fluoride, polystyrene sulfonate, poly(3,4-ethylenedioxythiophene), poly[2,5-bis(3-tetradecylthiophen-2-yl)thieno[3,2-b]thiophene], poly[2,5-bis(3-dodecylthiophen-2-yl)thieno[3,2-b]thiophene], poly[2,5-bis(3-hexadecylthiophen-2-yl)thieno[3,2-b]thiophene], poly[2,5-bis(3-octadecylthiophen-2-yl)thieno[3,2-b]thiophene], polythiophene, polytetrafluoroethylene, poly(perfluoro-3,6-dioxa-4-methyl-7-octene-sulfonic acid), or combinations thereof. In embodiments, the polymer may be selected from the group consisting of polyvinyl alcohol, polyethylene glycol, polyacrylic acid, poly(acrylamide-co-acrylic acid), polystyrene, polyvinylidene fluoride, polystyrene sulfonate, poly(3,4-ethylenedioxythiophene), poly[2,5-bis(3-tetradecylthiophen-2-yl)thieno[3,2-b]thiophene], poly[2,5-bis(3-dodecylthiophen-2-yl)thieno[3,2-b]thiophene], poly[2,5-bis(3-hexadecylthiophen-2-yl)thieno[3,2-b]thiophene], poly[2,5-bis(3-octadecylthiophen-2-yl)thieno[3,2-b]thiophene], polythiophene, polytetrafluoroethylene, poly(perfluoro-3,6-dioxa-4-methyl-7-octene-sulfonic acid), and combinations thereof. In embodiments, the polymer may comprise polyvinyl alcohol, polyethylene glycol, polyacrylic acid, poly(acrylamide-co-acrylic acid), or combinations thereof. In embodiments, the polymer can be selected from the group consisting of polyvinyl alcohol, polyethylene glycol, polyacrylic acid, poly(acrylamide-co-acrylic acid), and combinations thereof.

In embodiments where the polymer comprises poly(acrylamide-co-acrylic acid), the poly(acrylamide-co-acrylic acid) may have a molar ratio of acrylamide to acrylic acid of from 9:1: to 1:1. For instance, the poly(acrylamide-co-acrylic acid) may have a molar ratio of acrylamide to acrylic acid from 8:1 to 1:1, from, 7:1 to 1:1, from 6:1 to 1:1, from, 5:1 to 1:1, from 4:1 to 1:1, from, 3:1 to 1:1, or from 2:1 to 1:1.

In embodiments, the carboxylic acid linker may bridge two or more MOF intermediate compounds to produce the MOF. While not wishing to be bound by theory, it is believed that the carboxylic acid linker may bridge two or more metal-oxo cluster compounds from the metal solution to form the MOF. In embodiments, the carboxylic acid linker may comprise terephthalic acid, 2-hydroxyterephthalic acid, 2,5-dihydroxyterephthalic acid, 2-aminoterephthalic acid, 2,5-diaminoterephthalic acid, 2-sulfoterephthalic acid, 2,5-disulfoterephthalic acid, 2-methylterephthalic acid, 2,5-methylterephthalic acid, 2-phosphonoterephtahlic acid, 2,5-diphosphonoterephthalic acid, cyclohexane-1,2,4-tricarboxylic acid, 1,2,4,5-benzenetetracarboxylic acid, cyclohexane-1,2,4,5-tetracarboxylic acid, fumaric acid, 1,4-naphthalenedicarboxylic acid, biphenyl-4,4′-dicarboxylic acid, 2-amino-4,4′-biphenyldicarboxylic acid, 2-sulfo-4,4′-biphenyldicarboxylic acid, 1,3,5-benzenetriacetic acid (“trimesic acid”), 1,3,5-cyclohexanetricarboxylic acid, 2-methylimidazole, benzimidazole, 1,3,5-benzenetrisulfonic acid, 1,4-benzenedisulfonic acid, tetraethyl 4,4′,4″,4′″-(pyrene-1,3,6,8-tetrayl)tetrabenzoic acid, 1,3,6,8-tetrakis-(p-benzoic acid)pyrene, 4,4′,4″-(triazine-2,4,6-triyl-tris(benzene-4,1-diyl))tribenzoic acid, 4,4′,4″-(benzene-1,3,5-triyl-tris(benzene-4,1-diyl))tribenzoic acid, 4,4′,4‘ ’,4′ acid), or combinations thereof. In embodiments, the carboxylic acid linker may be selected from the group consisting of terephthalic acid, 2-hydroxyterephthalic acid, 2,5-dihydroxyterephthalic acid, 2-aminoterephthalic acid, 2,5-diaminoterephthalic acid, 2-sulfoterephthalic acid, 2,5-disulfoterephthalic acid, 2-methylterephthalic acid, 2,5-methylterephthalic acid, 2-phosphonoterephtahlic acid, 2,5-diphosphonoterephthalic acid, cyclohexane-1,2,4-tricarboxylic acid, 1,2,4,5-benzenetetracarboxylic acid, cyclohexane-1,2,4,5-tetracarboxylic acid, fumaric acid, 1,4-naphthalenedicarboxylic acid, biphenyl-4,4′-dicarboxylic acid, 2-amino-4,4′-biphenyldicarboxylic acid, 2-sulfo-4,4′-biphenyldicarboxylic acid, 1,3,5-benzenetriacetic acid (“trimesic acid”), 1,3,5-cyclohexanetricarboxylic acid, 2-methylimidazole, benzimidazole, 1,3,5-benzenetrisulfonic acid, 1,4-benzenedisulfonic acid, tetraethyl 4,4′,4″,4′″-(pyrene-1,3,6,8-tetrayl)tetrabenzoic acid, 1,3,6,8-tetrakis-(p-benzoic acid)pyrene, 4,4′,4″-(triazine-2,4,6-triyl-tris(benzene-4,1-diyl))tribenzoic acid, 4,4′,4″-(benzene-1,3,5-triyl-tris(benzene-4,1-diyl))tribenzoic acid, 4,4′,4‘ ’,4′ acid), and any combination thereof. In embodiments, the carboxylic acid linker can be selected from the group consisting of terephthalic acid, 2-aminoterephthalic acid, 1,3,6,8-tetrakis-(p-benzoic acid)pyrene, biphenyl-4,4′-dicarboxylic acid, 4,4′,4″,4′″-(Porphine-5,10,15,20-tetrayl)tetrakis(benzoic acid), and combinations thereof.

In embodiments, the product mixture may comprise from 0.5 wt. % to 15 wt. %. of the carboxylic acid linker, based on the total weight of the product mixture. For instance, in embodiments the product mixture may comprise from 0.5 wt. % to 10 wt. %, from 0.5 wt. % to 5 wt. %, from 0.5 wt. % to 4 wt. %, from 0.5 wt. % to 3 wt. %, from 0.5 wt. % to 2 wt. %, or from 0.5 wt. % to 1 wt. % of the carboxylic acid linker. While not wishing to be bound by theory, it is believed that a product mixture comprising less than 0.5 wt. % of the carboxylic acid linker may inhibit formation of the polymer-MOF-gel. Further, a product mixture comprising greater than 15 wt. % of the carboxylic acid linker may have a greater amount of insoluble carboxylic acid linker present, which may decrease the crystallinity of the polymer-MOF-gel.

In embodiments, the product mixture may comprise from 0.5 wt. % to 20 wt. % of the polymer, based on the total weight of the product mixture. For instance, the product mixture may comprise from 0.5 wt. % to 15 wt. %, from 0.5 wt. % to 10 wt. %, from 0.5 wt. % to 5 wt. %, from 1 wt. % to 20 wt. %, from 1 wt. % to 15 wt. %, from 1 wt. % to 10 wt. %, from 1 wt. % to 5 wt. %, from 2 wt. % to 20 wt. %, from 2 wt. % to 15 wt. %, from 2 wt. % to 10 wt. %, from 2 wt. % to 5 wt. %, from 2 wt. % to 4 wt. %, or from 2 wt. % to 3 wt. % of the polymer, based on the total weight of the product mixture. While not wishing to be bound by theory, it is believed that a product mixture comprising less than 0.5 wt. % of the polymer may not induce gelation to form the polymer-MOF-gel. Further, a product mixture comprising greater than 20 wt. % of the polymer may increase a viscosity of at least a portion of the product mixture, thereby inhibiting formation of the polymer-MOF-gel.

In embodiments, the product mixture may comprise from 0.05 wt. % to 1 wt. % of the metal salt, based on the total weight of the product mixture. For instance, the product mixture may comprise from 0.05 wt. % to 0.9 wt. %, from 0.05 wt. % to 0.8 wt. %, from 0.05 wt. % to 0.7 wt. %, from 0.05 wt. % to 0.6 wt. %, from 0.05 wt. % to 0.5 wt. %, from 0.05 wt. % to 0.4 wt. %, from 0.05 wt. % to 0.3 wt. %, or from 0.05 wt. % to 0.2 wt. % of the metal salt. While not wishing to be bound by theory, it is believed that a product mixture comprising less than 0.05 wt. % of the metal salt may inhibit formation of the polymer-MOF-gel. Further, a product mixture comprising greater than 1 wt. % of the metal salt may have a greater amount of insoluble metal salt present.

Upon forming the product mixture comprising the metal solution, the polymer mixture, and the carboxylic acid linker, the polymer-MOF-gel may be produced. In embodiments, the polymer-MOF-gel may comprise a polymer and a metal organic framework (MOF) having pores. In embodiments, at least a portion of the polymer may be entrapped in the pores of the MOF. Selection of the metal salt and carboxylic acid linker may be modified to yield the specific desired MOF of the polymer-MOF-gel using the methods described herein. Exemplary MOFs capable of being prepared by the above process include, but are not limited to, zirconium MOFs, such as UiO-66, UiO-66 (NH₂), UiO-67, NU-901, MOF-525, NU-1000, copper MOFs, such as HKUST1, and zinc MOFs, such as ZIF-8. Other MOFs may be prepared in accordance with the process described above. In general, MOF synthesis involves forming an ioncluster, which then reacts with the carboxylic acid linker to produce the MOF. A more complex metal ioncluster may require a longer synthesis time to form the ioncluster in a specific conformation. For instance, in the case of UiO-66, a hexanuclear zirconium oxocluster may be formed, although many other zirconium oxocluster species may exist, e.g. tetranuclear or zirconium ions. This step may be separated out to create a pre-formed ioncluster as a reactant, or the MOF may be formed using metal ions in solution. During the formation of the MOF, the polymer, as described herein is present in the mixture. It is believed that the polymer comprising certain side groups can interact with the ioncluster of the MOF intermediate, thereby entrapping the polymer in the pores of MOF, thereby forming the polymer-MOF-gel.

The formation of one or more MOFs in the polymer-MOF hydrogel may be confirmed using x-ray diffraction methods, such as grazing incidence x-ray diffraction (GIXD), as described herein, to compare the spectrum of the polymer-MOF-gel with a spectrum of a specific MOF alone. The formation of a gel in the polymer-MOF-gel may be confirmed using a gel inversion test, as described herein.

In embodiments, the polymer present in the polymer-MOF-gel may maintain one or more properties of the polymer used to form the polymer mixture, such as the side groups, the average mass, or the specific polymer, as described herein. For instance, in embodiments, the polymer of the polymer-MOF-gel may comprise, polar groups, carboxyl groups, lone pair electron groups, pi-stacking groups, or combinations thereof.

In embodiments, the polymer-MOF-gel may be a polymer-MOF-hydrogel. In embodiments, the polymer-MOF-hydrogel may be formed by contacting the polymer-MOF-gel with water. In embodiments, the contacting may include dialyzing the polymer-MOF-gel with water to form the polymer-MOF-hydrogel. While not wishing to be bound by theory, it is believed that the polymer-MOF-hydrogel may have improved biocompatibility compared to the polymer-MOF-gel due to the replacement of organic solvent molecules with water.

In embodiments, the polymer-MOF-gel and/or the polymer-MOF-hydrogel may have a shear storage modulus (G′) that is greater than a shear loss modulus (G″). In embodiments, the G′ and G″ are measured at an angular frequency from 0 radians per second (rad/s) to 10 rad/s using the rheology test method, as described herein. While not wishing to be bound by theory, it is believed that a product having a G′ that is greater than a G″ indicates the product has gel-like properties.

In embodiments, the polymer-MOF-gel and/or the polymer-MOF-hydrogel may have a G′ of at least 5 times, at least 6 times, at least 7 times, at least 8 times, at least 9 times, or at least 10 times greater than a G″ at 1 hertz (Hz) (6.28 rad/s). In embodiments, the polymer-MOF-gel and/or the polymer-MOF-hydrogel may have a G′ of up to 20 times greater than a G″ at 1 hertz (Hz) (6.28 rad/s). While not wishing to be bound by theory, it is believed that a larger G′ indicates increased gel stiffness, which may be desired in certain applications.

In embodiments, the MOF of the polymer-MOF-gel and/or the polymer-MOF-hydrogel may have a coherence length from 5 nm to 200 nm, as determined by the Scherrer equation. For instance, in embodiments, the coherence length may be from 5 nm to 150 nm, from nm to 100 nm, from 5 nm to 75 nm, from 5 nm to 50 nm, from 10 nm to 200 nm, from 10 nm to 150 nm, from 10 nm to 100 nm, from 10 nm to 75 nm, from 10 nm to 50 nm, from 20 nm to 200 nm, from 20 nm to 150 nm, from 20 nm to 100 nm, from 20 nm to 75 nm, from 20 nm to 50 nm, from 25 nm to 200 nm, from 25 nm to 150 nm, from 25 nm to 100 nm, from 25 nm to 75 nm, or from 25 nm to 50 nm. While not wishing to be bound by theory, it is believed that a higher coherence length demonstrates increased crystallinity of the MOF, which may increase the drug loading capacity of the polymer-MOF-gel, improve stability of the polymer-MOF-gel, or both.

In embodiments, the polymer-MOF-gel and/or the polymer-MOF-hydrogel may have a Brunauer-Emmett-Teller specific surface area of from 30 m²/g to 1000 m²/g, as determined by the N₂ adsorption isotherm test method, as described herein. For instance, in embodiments, the polymer-MOF-gel and/or the polymer-MOF-hydrogel may have a BET specific surface area from 30 m²/g to 800 m²/g, from 30 m²/g to 600 m²/g, from 30 m²/g to 500 m²/g, from 30 m²/g to 400 m²/g, from 30 m²/g to 300 m²/g, from 30 m²/g to 200 m²/g, from 30 m²/g to 100 m²/g, from 40 m²/g to 1000 m²/g, from 40 m²/g to 800 m²/g, from 40 m²/g to 600 m²/g, from 40 m²/g to 500 m²/g, from 40 m²/g to 400 m²/g, from 40 m²/g to 300 m²/g, from 40 m²/g to 200 m²/g, or from 40 m²/g to 100 m²/g. While not wishing to be bound by theory, it is believed that a higher specific surface area can increase a loading capacity of the polymer-MOF-gel and/or the polymer-MOF-hydrogel.

In embodiments, the polymer-MOF-gel and/or the polymer-MOF-hydrogel may be contacted with a solution comprising one or more drug compounds, thereby loading at least a portion of the one or more drug compounds in the polymer-MOF-gel and/or the polymer-MOF-hydrogel. As used herein, “drug compounds” refers to any chemical material that may be used for medical treatment, which may include materials such as metal ions, small molecules, peptides, DNA, RNA, or proteins. While not wishing to be bound by theory, it is believed that the drug compounds may be loaded into the pores of the MOF of the polymer-MOF-gel and/or the polymer-MOF hydrogel. In embodiments, the polymer-MOF-gel and/or the polymer-MOF-hydrogel may comprise greater than or equal to 2 wt. % of the one or more drug compounds, based on the total weight of the polymer-MOF-gel and/or the polymer-MOF-hydrogel when dried. For instance, in embodiments, the polymer-MOF-gel and/or the polymer-MOF-hydrogel may comprise greater than or equal to 3 wt. %, greater than or equal to 4 wt. %, greater than or equal to 5 wt. %, greater than or equal to 6 wt. %, greater than or equal to 7 wt. %, greater than or equal to 8 wt. %, greater than or equal to 9 wt. %, or even greater than or equal to 10 wt. % of the one more drug compounds, based on the total weight of the polymer-MOF-gel and/or the polymer-MOF-hydrogel when dried. In embodiments, the polymer-MOF-gel and/or the polymer-MOF-hydrogel may comprise less than or equal to 20 wt. %, less than or equal to 15 wt. %, or less than or equal to 12 wt. % of the one more drug compounds, based on the total weight of the polymer-MOF-gel and/or the polymer-MOF-hydrogel when dried. While not wishing to be bound by theory, it is believed that the polymer-MOF-gels and/or the polymer-MOF-hydrogels, as described herein may be able to load a greater amount of drug compound in comparison to the MOF alone or a physical mixture comprising the MOF and the polymer-gel.

In embodiments, the polymer-MOF-gel and/or the polymer-MOF-hydrogel comprising the one or more drug compounds may release at least a portion of the drug compound. In embodiments, the drug compounds may be released over a period of time, such as at least 7 days, at least 14 days, or even at least 21 days. In embodiments, the polymer-MOF-gel and/or the polymer-MOF-hydrogel may release greater than or equal to 10%, greater than or equal to 15%, greater than or equal to 20%, greater than or equal to 25%, greater than or equal to 30%, greater than or equal to 35%, or even greater than or equal to 40% of the drug compound over a specific period of time, relative to the total amount of the drug compound loaded in the polymer-MOF-gel and/or the polymer-MOF-hydrogel. In embodiments, the polymer-MOF-gel and/or the polymer-MOF-hydrogel may release up to 100%, up to 90%, up to 80%, up to 70%, up to 60%, or up to 50% of the drug compound over the specific period of time.

### Test Methods

The following test methods illustrate features of the present disclosure but are not intended to limit the scope of the disclosure.

### Grazing Incidence X-Ray Diffraction (GIXD)

The GIXD experiments were performed at beamline 11-3 in the Stanford Synchrotron Radiation Lightsource (SSRL) at SLAC National Laboratory (Menlo Park, California) with a beam energy of 12.7 keV. 2D diffraction patterns were recorded with Rayonix MX225 detector with a sample to detector distance of 315 mm. The 2D patterns were integrated using the pyFAI module in Python to obtain 1D patterns.

### Scanning Electron Microscopy (SEM)

Gel samples were dried at 80° C. in an oven prior to characterization. The dry gel was coated with a layer of Au/Pd using Gatan 682 Precision Etching and Polishing System (PECS). SEM images of the dry gel were obtained using a FEI quanta 650 field-emission secondary electron microscope. The accelerating voltage of the primary beam was kept between 1 kV and 5 kV, and the spot size was kept below 4.

### Transmission Electron Microscopy (TEM)

Gel samples were placed on a TEM grid and washed with 3 drops of water and 2 drops of 2% uranyl acetate (UA) followed by incubating in one drop of UA for 1 minute. Samples were then blotted and dried under air. TEM images of the gel were obtained using a Tecnai F20 electron microscope at magnifications ranging from 400× to 29000× and recorded on a Teitz TVIPS XF416 camera.

### Rheology

Gel samples were cut with an 8 mm biopsy punch immediately prior to oscillatory frequency sweeps (0.01 to 100 Hz at 1% strain) on a TA Instruments DHR Rheometer with 8 mm parallel plate geometry at 25° C. Samples found to have defects or heterogeneity from visual examination were rejected. A normal stress of 0.1 Newtons of axial force was applied before the samples were sheared to prevent slipping. Amplitude sweeps from 0.1% strain to 100% strain were run to ensure frequency sweep measurements were conducted in the linear viscoelasticity range.

### N₂ Adsorption Isotherms

The nitrogen adsorption isotherm was recorded using a Micromeritics ASAP2020 Surface Area and Porosity Analyzer. The dry gel was degassed at 80° C. for 16 hours under vacuum before the analysis. The surface area was determined using Brunauer-Emmett-Teller (BET) theory. Data points from P/Pₒ=0.01 to 0.05 were used to calculate the surface area.

### Fourier Transform Infrareds Oscopy-Attenuated Total Reflection (FTIR-ATR)

FTIR spectra of the dry gel were obtained from a PerkinElmer Frontier MIR/NIR. The background subtraction was performed before recording the FTIR spectra. A total of 8 scans were performed for each sample and an average of 8 scans is reported.

### Themogravimetric Analysis (TGA)

TGA analysis was performed using a Q-50 thermogravimetric analyzer. The samples were heated from room temperature to 1000° C./min at a rate of 10° C./min.

### Gel Inversion Test

A gel inversion test was used to determine if gel formation was induced in the examples. After forming a product mixture, as detailed in the examples below, the product mixture was left undisturbed for 14 days before conducting the gel inversion test. The examples were inverted in a sealed 20 mL vial. If the material flowed to the lid of the vial upon inversion (lower portion of vial when inverted), it was determined that gel formation was not induced. If the material did not flow and remained suspended in the vial (higher portion of vial when inverted), it was determined that gel formation was induced. If a portion of the material formed a solid gel that did not flow, and another portion that did flow, it was determined that partial gel formation was induced.

### Loading Experiments

A known mass of sorbent (polymer-MOF hydrogel, physical mixture, PVA-Zr-oxo hydrogel, or MOF powder) was added to an aqueous solution comprising the small molecule, such as methylene blue. A parallel system where a similar mass of sorbent was added to ultrapure water as a control sample. In both cases the ratio of sorbent mass to solution volume was held constant across each study. Immediately after adding the sorbent, an aliquot was removed from each solution, which served as the initial (day 0) absorbance. Aliquots were removed from the solution at various timepoints over 7 days to track m_{L,t}, the mass of the solute (mg) sorbed at time t. Each aliquot was replaced with an equal volume of ultrapure water after removal to keep the total solution volume constant. m_{L,t} was calculated from the UV absorbance of the outer solution using equation (i),

$${m}_{L , t} = \frac{V * m * 1000}{K} [ {Abs}_{0} - ( {Abs}_{t} + {\sum }_{i = 0}^{t - 1} [ {Abs}_{i} * \frac{{V}_{a}}{V} ] ) ] \qquad ( i )$$

where mₜ is the mass of solute (mg) sorbed at time t, Absₜ is the absorbance of the outer solution at time t, V is the volume of the outer solution (L), m is the molecular weight of the solute, K is the molar absorptivity coefficient (L/mol*cm), and Vₐ is the volume of an aliquot (L). In equation (i), Absₜ represents the difference between the absorbance of the test sample and control sample, both relative to the absorbance of a ultrapure water. All absorbance measurements were completed on a Biotek Synergy 4 plate reader. Error bars on loading plots represent the error between measurements from 3 independently synthesized sorbents. The solute loading capacity of each sorbent is the amount of solute loaded relative to the dry mass of the sorbent, which refers to the mass of the polymer-MOF hydrogel, PVA-Zr-oxo gel, or physical mixture after lyophilization, and is meant to provide a more direct loading comparison between the hydrogel samples and the MOF powder. Solute loading capacity is defined in equation (ii), where m_{sorbent} is the dry mass of the sorbent (mg).

$$LC = \frac{{m}_{L , 7}}{{m}_{sorbent}} \qquad ( ii )$$

### Release Experiments

After 7 days, the outer solution in all the test and control samples from the loading experiments was removed and replaced with an equal volume of ultrapure water. An aliquot was immediately removed from each solution, which served as the initial (day 0) absorbance. Aliquots were removed from the solution at various timepoints over 21 days to track m_{R,t} the mass of solute (mg) released from the sorbent at time t. Each aliquot was replaced with an equal volume of ultrapure water after removal to keep the solution volume constant. m^{R,t} was calculated from the UV absorbance of the outer solution using equation (iii):

$${m}_{R , t} = \frac{V * m * 1000}{K} [ ( A b {s}_{t} + {\sum }_{i = 0}^{t - 1} [ {Abs}_{i} * \frac{{V}_{a}}{V} ] ) - {Abs}_{0} ] \qquad ( iii )$$

All absorbance measurements were completed on a Biotek Synergy 4 plate reader. Error bars on loading plots represent the error between measurements from 3 independently synthesized sorbents. The % of solute released is the mass of solute released relative to the mass loaded into the sorbent after 7 days, and is defined in equation (iv):

$$\% of solute released = \frac{{m}_{R , t}}{{m}_{L , 7}} * 100 \% \qquad ( iv )$$

### Coherence Length

The coherence length of the examples was calculated using the Scherrer equation, as defined is equation (v):

$$τ = \frac{κ λ}{β cos θ}$$

where:
τ is the mean size of the ordered (crystalline) domains, which may be smaller or equal to the grain size, which may be smaller or equal to the particle size; κ is a dimensionless shape factor, with a value close to unity; λ is the X-ray wavelength; β is the line broadening at half the maximum intensity (FWHM), after subtracting the instrumental line broadening, in radians; and θ is the Bragg angle.

### EXAMPLES

The various embodiments disclosed herein will be further clarified by the following examples. The examples are illustrative in nature, and should not be understood to limit the embodiments disclosed herein. The materials of Table 1 were used in the examples.

TABLE 1

| Abbreviation | Chemical name | Supplier |
|---|---|---|
| Zr(OnPr)₄ | Zirconium (IV) propoxide solution (70 | Sigma Aldrich Chemical |
| | wt. % in 1-propanol) | Company |
| PVA | Polyvinyl alcohol (99%+ hydrolyzed) | Sigma Aldrich Chemical |
| | | Company |
| PEG | Polyethylene glycol | Sigma Aldrich Chemical |
| | | Company |
| PAA | Polyacrylic acid | Sigma Aldrich Chemical |
| | | Company |
| PAAA | Poly(acrylamide-co-acrylic acid) | Polymer Source Inc. |
| | (acrylamide: acrylic acid = 9:1) | |
| H₂BDC | terephthalic acid (98%) | Sigma Aldrich Chemical |
| | | Company |
| H₂ATA | 2-aminoterephthalic acid (99%) | Sigma Aldrich Chemical |
| | | Company |
| H₄TBAPy | 1,3,6,8-tetrakis (p-benzoic acid) pyrene | Synthesized¹ |
| BPDC | biphenyl-4,4′-dicarboxylic acid (97%) | Sigma Aldrich Chemical |
| | | Company |
| TCPP | 4,4′,4″,4″′-(Porphine-5,10,15,20- | Sigma Aldrich Chemical |
| | tetrayl)tetrakis(benzoic acid) (dye | Company |
| | content 75%) | |
| NaOH | Sodium hydroxide (≥97%) | Sigma Aldrich Chemical |
| | | Company |
| CH₃COOH | Acetic acid (≥99.7%) | Sigma Aldrich Chemical |
| | | Company |
| DMSO-d₆ | Deuterated dimethyl sulfoxide (≥99.8%) | Sigma Aldrich Chemical |
| | | Company |
| DMSO | Dimethyl sulfoxide (≥ 99.9%) | Thermo Fisher Scientific |
| ZrOCl₂•8H₂O | Zirconyl chloride octahydrate (98%) | Thermo Fisher Scientific |

¹Synthesized according to Wang, T. C.; Vermeulen, N. A.; Kim, I. S.; Martinson, A. B. F.; Stoddart, J. F.; Hupp, J. T.; Farha, O. K. Scalable Synthesis and Post-Modification of a Mesoporous Metal-Organic Framework Called NU-1000. Nat. Protoc. 2016, 11 (1), 149-162. https://doi.org/10.1038/nprot.2016.001.

### Example 1. Synthesis of Zr-Oxo Cluster Solution

In a 20 mL glass vial, 355 μL of Zr(OnPr)₄ (0.79 mmol) and 4 mL of acetic acid (70 mmol) were added to 7 mL of DMSO. The solution was sonicated for 10 minutes and then kept inside the oven at 130° C. for 2 h. After heating, the solution was cooled to room temperature. The resulting solution is referred to herein as “Zr-oxo cluster solution” or Example 1. A Zr-oxo cluster solution is an ioncluster that may be used to react with a carboxylic acid linker to form a MOF, or may be used without a carboxylic acid linker for comparison in the examples that follow.

### Comparative Example A. Synthesis of Polymer-Zr-Oxo Gels without a Carboxylic Acid Linker

Comparative examples were prepared according to Table 2:

TABLE 2

| | | Wt. % of polymer | Average mass of |
|---|---|---|---|
| Example | Polymer | in product mixture | polymer (kDa) |
| Comparative | PVA | 2 | 146-186 |
| Example A-1 | | | |
| Comparative | PEG | 2 | >100 |
| Example A-2 | | | |
| Comparative | PAA | 2 | 450 |
| Example A-3 | | | |
| Comparative | PAAA | 2 | 210 |
| Example A-4 | | | |

Specifically, 220 mg of the polymer, according to Table 2, was dissolved into 5 mL of DMSO by heating the mixture on a hot plate at 130° C. and stirring it continuously to form a polymer mixture. The polymer mixture was allowed to cool to room temperature. 5 mL of Zr-oxo cluster solution of Example 1 was added to the polymer mixture to form a product mixture, and the product mixture was shaken for one minute. Then, the product mixture was kept at room temperature for 14 days.

### Comparative Example B. Synthesis of Polymer-UiO-66 Physical Mixture: Formation of UiO-66 MOF and Subsequent Polymer Addition

Comparative examples were prepared according to Table 3:

TABLE 3

| | | Wt. % of | Average mass | |
|---|---|---|---|---|
| | | polymer in | of polymer | Carboxylic |
| Example | Polymer | product mixture | (kDa) | acid linker |
| Comparative | PVA | 2 | 146-186 | H₂BDC |
| Example B-1 | | | | |
| Comparative | PEG | 2 | >100 | H₂BDC |
| Example B-2 | | | | |
| Comparative | PAA | 2 | 450 | H₂BDC |
| Example B-3 | | | | |
| Comparative | PAAA | 2 | 210 | H₂BDC |
| Example B-4 | | | | |

Specifically, a UiO-66 solution was prepared by combining 10 mL of Zr-oxo cluster solution of Example 1 with 120 mg of H₂BDC. The H₂BDC was dissolved in the Zr-oxo cluster solution using sonication. The mixture was heated at 130° C. for 2 days. After heating, the solution was cooled to room temperature, and is denoted herein as the “UiO-66 solution”. This UiO-66 solution included UiO-66 MOF that was formed. 220 mg of the polymer, according to Table 3, was dissolved into 5 mL of DMSO by heating the mixture on a hot plate heated at 130° C. and stirring it continuously to form a polymer mixture. The polymer mixture was allowed to cool to room temperature. 5 mL of the UiO-66 solution was added to the polymer mixture to form a product mixture. The product mixture was shaken for 1 minute and kept at room temperature for 2 days.

### Example 2. Synthesis of Polymer UiO-66 Gels: Formation of UiO-66 MOF in the Presence of Polymer

Examples were prepared according to Table 4:

TABLE 4

| | | Wt. % of | Average mass | |
|---|---|---|---|---|
| | | polymer in | of polymer | Carboxylic |
| Example | Polymer | product mixture | (kDa) | acid linker |
| Example 2-1 | PVA | 2 | 146-186 | H₂BDC |
| Example 2-2 | PEG | 2 | >100 | H₂BDC |
| Example 2-3 | PAA | 2 | 450 | H₂BDC |
| Example 2-4 | PAAA | 2 | 210 | H₂BDC |

Specifically, 220 mg of the polymer, according to Table 4, was dissolved into 5 mL of DMSO by heating the mixture on a hot plate at 130° C. and stirring it continuously to form a polymer mixture. The polymer mixture was allowed to cool to room temperature. 120 mg of H₂BDC was dissolved into the polymer solution, forming a polymer linker mixture. 5 mL of the Zr-oxo cluster solution of Example 1 was added to the polymer linker mixture to form a product mixture, which was shaken for one minute, and kept at room temperature for 2 days. The wt. % of the polymer in the product mixture was approximately 2 weight percent (wt. %).

Analysis of Comparative Examples A-1 and B-1 and Example 2-1—The PVA-Zr-oxo mixture (Comparative Example A-1), PVA-UiO-66 physical mixture (Comparative Example B-1) and the PVA-UiO-66 gel (Example 2-1) were further analyzed. As determined by the gel-inversion test, as described herein, Comparative Example A-1 and Example 2-1 induced gel formation. While not wishing to be bound by theory, it is believed that non-covalent chemical interactions between hydroxyl groups present in PVA and the Zr-oxo clusters induce gel formation. Comparative Example B-1 did not induce gel formation. While not wishing to be bound by theory, it is believed that since the UiO-66 MOF was formed before introducing PVA in Comparative Example B-1, the polymer was unable to enter the pores of the MOF and form a polymer-MOF-gel.

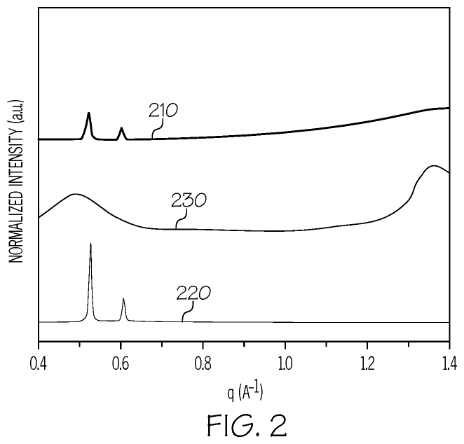

Referring now to FIG. 2, to determine the presence UiO-66 particles, Comparative Example A-1 and Example 2-1 were analyzed using GIRD. The diffraction pattern of Example 2-1 210 showed the characteristic peaks of UiO-66 220, confirming the formation of UiO-66 particles in the gel matrix. As a comparison, no UiO-66 peaks were observed in the diffraction pattern of Comparative Example A-1230. As a carboxylic acid linker was not used in Comparative Example A1, a MOF was not produced.

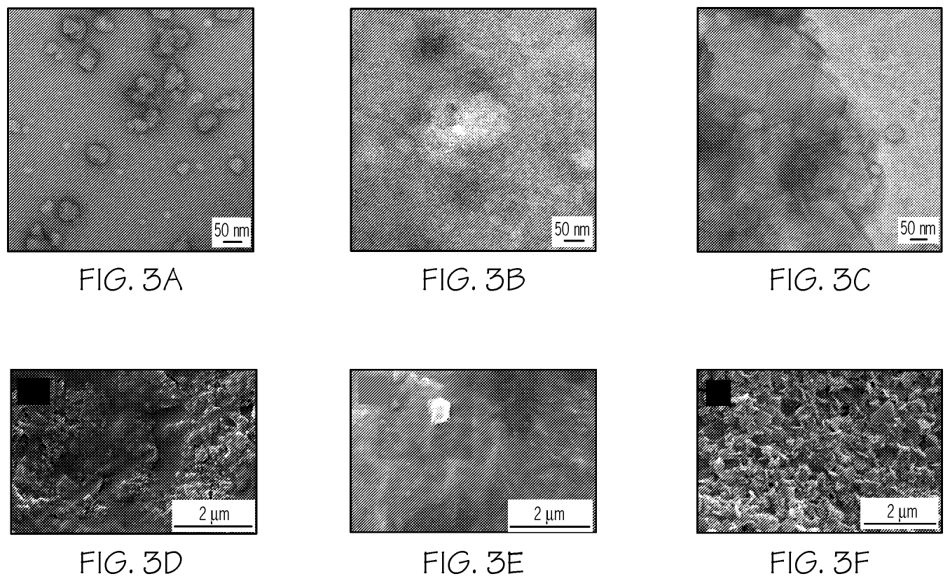

Referring now to FIGS. 3A-3F, the morphology of the examples were analyzed using TEM and SEM. The TEM image of Example 2-1 (FIG. 3A) showed the presence of particle-like morphology. The SEM image of Example 2-1 (FIG. 3D) further corroborated these results as spherical particles were observed. On the other hand, Comparative Example A-1 showed no particle like morphology in the TEM (FIG. 3B) and SEM (FIG. 3E) images. Comparative Example B-1 showed hexagonal shaped UiO-66 particles in an aggregated state in the TEM (FIG. 3C) and SEM (FIG. 3F) images.

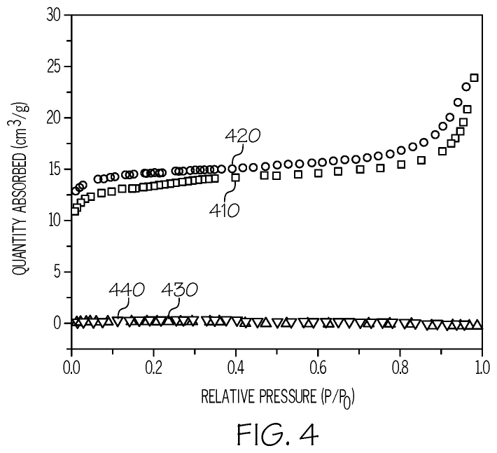

Referring now to FIG. 4, the porosity of the gels formed in Comparative Example A-1 (PVA-Zr-oxo-gel) and Example 2-1 (PVA-UiO-66-gel) were determined using nitrogen (N₂) adsorption and desorption isotherms. Before the analysis, the gels were dialyzed with water to remove DMSO from the gel structure and the dialyzed gels were dried at room temperature. The drying of the gels by heating was avoided to prevent cross-linking of PVA chains. The adsorption and desorption isotherms of the dried gels are illustrated in FIG. 4. The adsorption 410 and desorption 420 of Example 2-1 showed nitrogen uptake in the microporous region (P/Pₒ˜0.01-0.2) and the hysteresis indicated the presence of mesopores in the gel structure. While not wishing to be bound by theory, it is believed the microporous nature of Example 2-1 was due to the presence of UiO-66 particles, while the voids created between the PVA and UiO-66 particles contributed to the mesopores. The calculated Brunauer-Emmett-Teller (BET) specific surface area of Example 2-1 was 50 m²/g. In comparison, Comparative Example A-1 absorbed a negligible amount of N₂, which demonstrated ultralow porosity of the dried gel, as shown by the absorption 430 and desorption 440 spectra. Additionally, the BET specific surface area of the PVA-Zr-oxo gel was 0.24 m²/g. Thus, as exemplified by Example 2-1, the addition of the carboxylic acid linker, H₂BDC, to the PVA solution provides enhanced porosity of the gel formed therefrom, which may increase a loading capacity of polymer-MOF-gel.

Analysis of Comparative Examples A-2 and B-2 and Example 2-2—The PEG-Zr-oxo mixture (Comparative Example A-2), PEG-UiO-66 physical mixture (Comparative Example B-2) and the PEG-UiO-66 gel (Example 2-2) were further analyzed. As determined by the gel inversion test, Example 2-2 induced gel formation. Comparative Examples A-2 and B-2 did not induce gel formation.

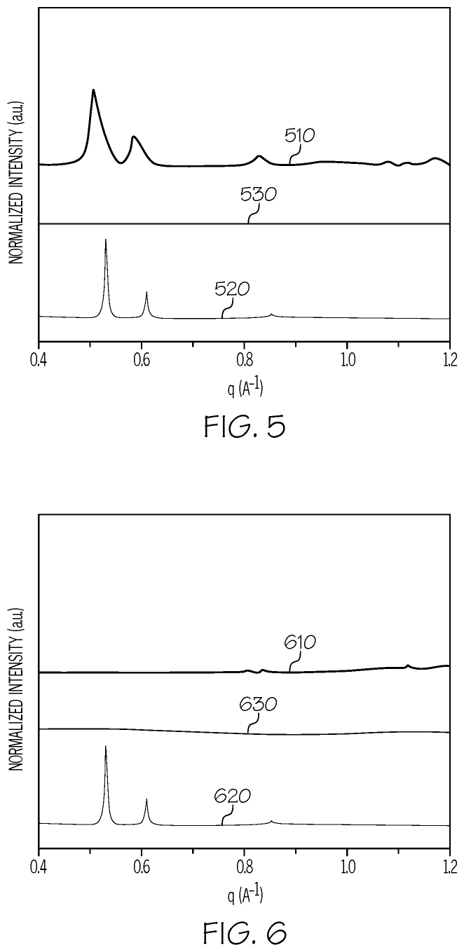

Referring now to FIG. 5, to determine the presence UiO-66 particles, Comparative Example A-2 and Example 2-2 were analyzed using GIRD. The diffraction pattern of Example 2-2 510 showed the characteristic peaks of UiO-66 520, confirming the formation of UiO-66 particles in the gel matrix. As a comparison, no UiO-66 peaks were observed in the diffraction pattern of Comparative Example A-2 530. While not wishing to be bound by theory, as PEG has a negligible amount of hydroxyl groups, it is believed that there were reduced chemical interactions between the PEG chains and Zr-oxo clusters in Comparative Example A-2, inhibiting gel formation. Mixing preformed UiO-66 with PEG to form the PEG-UiO-66 physical mixture (Comparative Example B-2) did not induce gel formation. Regarding Example 2-2, while not wishing to be bound by theory, it is believed that the PEG was entrapped in the UiO-66 pores, resulting in restricted movement of the PEG and inducing gel formation in the polymer-MOF-gel.

Analysis of Comparative Examples A-3 and B-3 and Example 2-3—The PAA-Zr-oxo mixture (Comparative Example A-3), PAA-UiO-66 physical mixture (Comparative Example B-3) and the PAA-UiO-66 gel (Example 2-3) were further analyzed. As determined by the gel-inversion test, Example 2-3, which included a carboxylic acid linker, and Comparative Example A-3, which did not include a carboxylic acid linker, induced gel formation. Comparative Examples B-3, which combined a polymer with the preformed MOF did not induce gel formation. While not wishing to be bound by theory, it is believed that since the UiO-66 MOF was formed before introducing PAA in Comparative Example B-3, the polymer was unable to enter the pores of the MOF and form a polymer-MOF-gel.

Referring now to FIG. 6, to determine the presence UiO-66 particles, Comparative Example A-3 and Example 2-3 were analyzed using GIXD. The diffraction patterns of Example 2-3 610 did not show the characteristic peaks of UiO-66 620. Comparative Example A-3 did not show the characteristic peaks of UiO-66 620. These results confirmed the lack of UiO-66 particles in the gel matrix of Example 2-3 and Comparative Example A-3. PAA has carboxyl groups, which may form coordination bonds with the Zr-oxo clusters. While not wishing to be bound by theory, it is believed that the carboxyl groups of PAA compete with the carboxylic acid linker to bind to the Zr-oxo cluster, inhibiting the UiO-66 formation.

Analysis of Comparative Examples A-4 and B-4 and Example 2-4—The PAAA-Zr-oxo mixture (Comparative Example A-4), PAAA-UiO-66 physical mixture (Comparative Example B-4) and the PAAA-UiO-66 gel (Example 2-4) were further analyzed. As determined by the gel-inversion test, Example 2-4, which included a carboxylic acid linker, and Comparative Example A-4, which did not include a carboxylic acid linker, induced gel formation. Comparative Example B-4 did not induce gel formation.

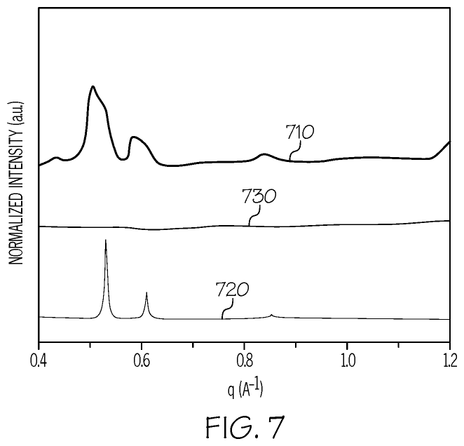

Referring now to FIG. 7, to determine the presence UiO-66 particles, Comparative Example A-4 and Example 2-4 were analyzed using GIRD. The diffraction pattern of Example 2 4 710 showed characteristic peaks of UiO-66 720, confirming the formation of UiO-66 particles in the gel matrix. As a comparison, no UiO-66 peaks were observed in the diffraction pattern of Comparative Example A-4 730. The PAAA used in the examples had a reduced density of carboxyl groups (˜10%) in comparison to PAA. As exemplified by Example 2-4, while carboxyl-containing polymers can compete with carboxylic acid linkers to inhibit MOF formation, lowering the carboxyl group density of the polymer allows for the formation of a polymer-MOF-gel.

### Comparative Example C. Synthesis of PEG UiO-66 Mixtures

Examples were prepared according to Example 2-2, but the amount of PEG used was modified to yield a varied amount of PEG in the product mixture, and the average mass of PEG was reduced, according to Table 5:

TABLE 5

| | | Wt. % of PEG | | |
|---|---|---|---|---|
| | | in product | Average mass of | Carboxylic |
| Example | Polymer | mixture | PEG (kDa) | acid linker |
| Comparative | PEG | 2 | 20 | H₂BDC |
| Example C-1 | | | | |
| Comparative | PEG | 6 | 20 | H₂BDC |
| Example C-2 | | | | |
| Comparative | PEG | 8 | 20 | H₂BDC |
| Example C-3 | | | | |
| Comparative | PEG | 10 | 20 | H₂BDC |
| Example C-4 | | | | |

Comparative Example C-1, which included PEG with shorter chain lengths (20 kDa) at the same amount as Example 2-2, did not induce gel formation. Further, increasing the amount of PEG to 6 wt. %, 8 wt. %, and 10 wt. % did not induce gel formation in Comparative Examples C-2, C-3, and C-4, respectively. While not wishing to be bound by theory, it is believed that polymers, such as PEG, having side groups that are weakly interacting with the metal-oxo cluster, in addition to shorter chain lengths, may not be able to form polymer-MOF-gels.

### Example 3. Synthesis of PVA-UiO-66 Gels with Varied PVA Amounts

PVA-UiO-66 gels were prepared according to Example 2-1, but the amount of PVA used was modified to yield a varied amount of PVA in the product mixture, according to Table 6:

TABLE 6

| | | Wt. % of PVA | | |
|---|---|---|---|---|
| | | in product | Average mass of | Carboxylic |
| Example | Polymer | mixture | PVA (kDa) | acid linker |
| Example 3-1 | PVA | 0.1 | 146-186 | H₂BDC |
| Example 3-2 | PVA | 0.5 | 146-186 | H₂BDC |
| Example 3-3 | PVA | 1 | 146-186 | H₂BDC |
| Example 3-4 | PVA | 1.5 | 146-186 | H₂BDC |
| Example 3-5 | PVA | 3 | 146-186 | H₂BDC |

Examples 3-1 and 3-2, having 0.1 wt. % and 0.5 wt % PVA, respectively, did not induce gel formation. Increasing the amount of PVA in the product mixture to 1 wt. % and 1.5 wt. % (Examples 3-3 and 3-4, respectively) resulted in partial gel formation. Increasing the amount of PVA in the product mixture to 3 wt. % (Example 3-5) induced gel formation.

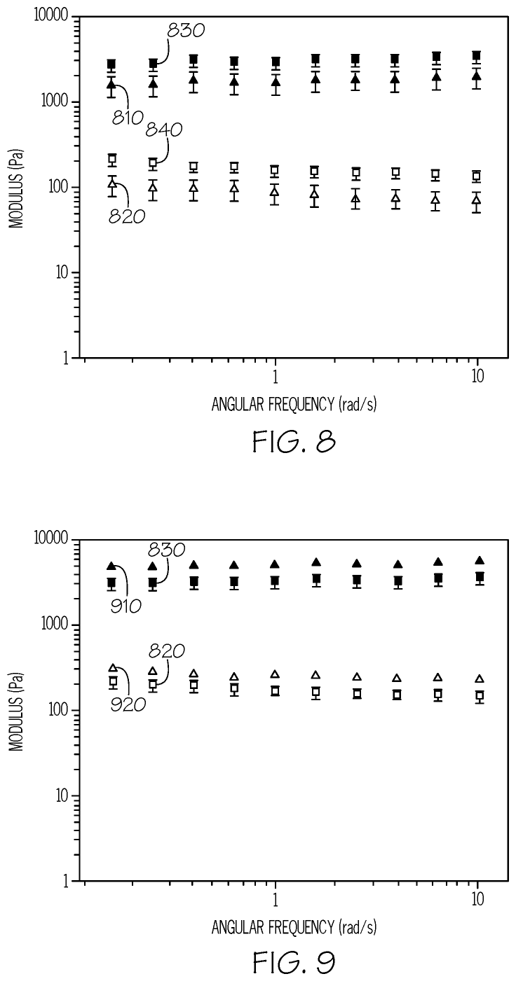

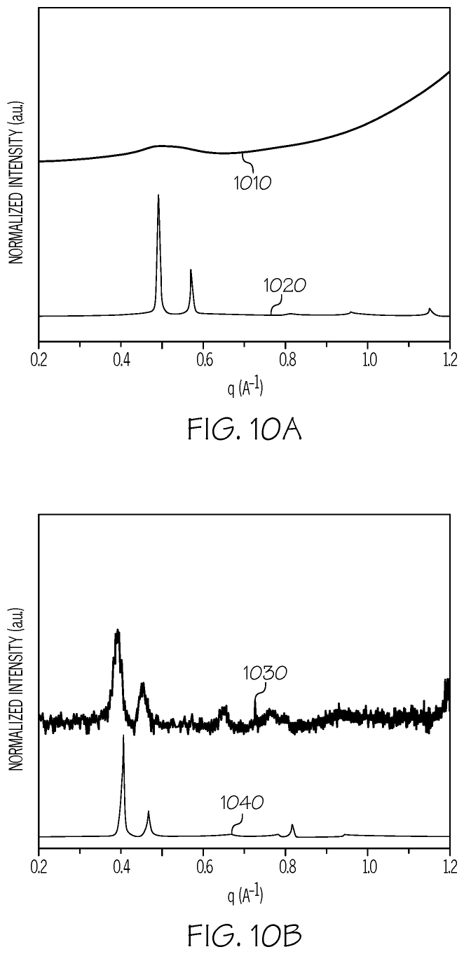

The gel mechanics of Comparative Example A-1, Example 2-1, and Example 3-5 were analyzed with oscillatory shear rheology. Referring now to FIG. 8, Comparative Example A-1 had shear storage moduli (G′) 810 greater than shear loss moduli (G″) 820, and Example 2-1 had G′ 830 greater than G″ 840 over a range of frequencies, indicating gel-like behavior. Referring now to FIG. 9, Example 3-5 had a G′ 910 greater than the G″ 920 over a range of frequencies, indicating gel-like behavior. The 3 wt % PVA-UiO-66 gel (Example 3-5) had a higher G′ than the 2 wt % PVA-UiO-66 gel (Example 2-1) 830, indicating that Example 3-5 was stiffer than Example 2-1. As exemplified by Example 2-1 and Example 3-5, increased bridging of polymer chains by the UiO-66 particles leads to PVA-UiO-66 gels having a higher stiffness.

### Example 4. Synthesis of PVA-UiO-66 Gels with PVA of Varying Average Mass and Amount

PVA-UiO-66 gels were prepared according to Example 2-1, but the amount of PVA used was modified to yield a varied amount of PVA in the product mixture and the average mass of PVA was modified, according to Table 7.

TABLE 7

| | | Wt. % of PVA | Average mass of | Carboxylic |
|---|---|---|---|---|
| Example | Polymer | in product | PVA (kDa) | acid linker |
| Example 4-1 | PVA | 2 | 9-10 | H₂BDC |
| Example 4-2 | PVA | 3 | 9-10 | H₂BDC |
| Example 4-3 | PVA | 4 | 9-10 | H₂BDC |
| Example 4-4 | PVA | 2 | 31-50 | H₂BDC |
| Example 4-5 | PVA | 3 | 31-50 | H₂BDC |
| Example 4-6 | PVA | 4 | 31-50 | H₂BDC |

Examples 4-1, 4-2, and 4-3, which included short PVA chains (9-10 kDa), did not induce gel formation. While not wishing to be bound by theory, it is believed that the shortening of the PVA chain may result in poor entanglement and chain cross-linking, which may limit gel formation. Example 4-4, which included 2 wt. % intermediate PVA chains (31-50 kDa), did not induce gel formation. However, increasing the PVA amount to 3 wt. % and 4 wt. % (Examples 4-5 and 4-6, respectively) did induce gel formation. As exemplified by Examples 4-1 to 4-6, both the average mass and the amount of the polymer play an important role in the formation of polymer-MOF-gels. In some instances, a selected polymer, which has an intermediate average mass (31-50 kDa), may not form a polymer-MOF-gel unless a sufficient amount of said polymer is used. Example 4-4, which included 2 wt. % 31-50 kDa PVA, did not form the polymer-MOF-gel, but increasing the amount to 3 wt. % (Example 4-5) did form the polymer-MOF-gel. In other instances where the selected polymer included a lower average mass (9-10 kDa), increasing the amount up to 4 wt. % still did not lead to the formation of a polymer-MOF-gel (Example 4-3).

### Example 5. Synthesis of PVA MOF Gels with Different Carboxylic Acid Linkers to Form Different MOFs

PVA-MOF gels were prepared according to Example 2-1, but the carboxylic acid linker was modified to yield a different MOF in the PVA-MOF-gel, and the wt. % of PVA in the gels were modified according to Table 8:

TABLE 8

| | | Wt. % of PVA | | | |
|---|---|---|---|---|---|
| | | in product | Average mass of | Carboxylic | MOF |
| Example | Polymer | mixture | PVA (kDa) | acid linker | Formed |
| Example 5-1 | PVA | 2 | 146-186 | H₂ATA | UiO-66-NH₂ |
| Example 5-2 | PVA | 2 | 146-186 | H₄TBSPy | NU-901 |
| Example 5-3 | PVA | 2 | 146-186 | PBDC | UiO-67 |
| Example 5-4 | PVA | 2 | 146-186 | TCPP | MOF-525 |
| Example 5-5 | PVA | 3 | 146-186 | H₂ATA | UiO-66-NH₂ |
| Example 5-6 | PVA | 3 | 146-186 | H₄TBSPy | NU-901 |
| Example 5-7 | PVA | 3 | 146-186 | PBDC | UiO-67 |
| Example 5-8 | PVA | 3 | 146-186 | TCPP | MOF-525 |

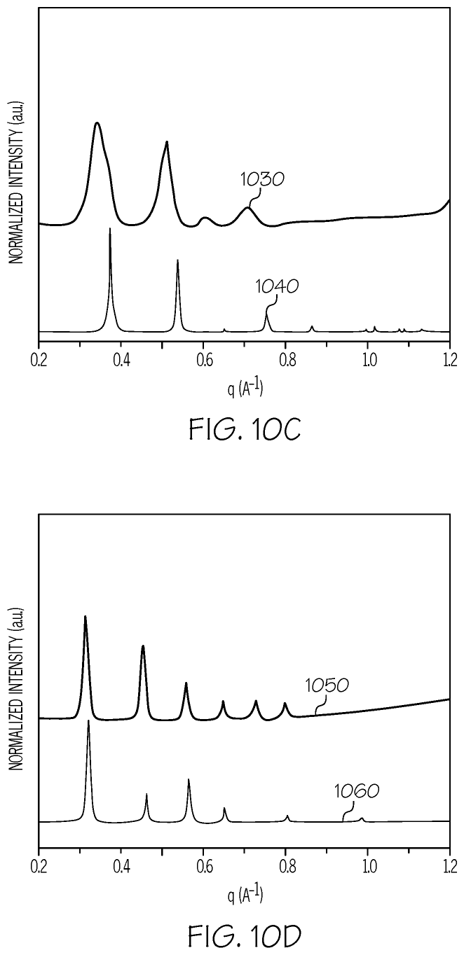

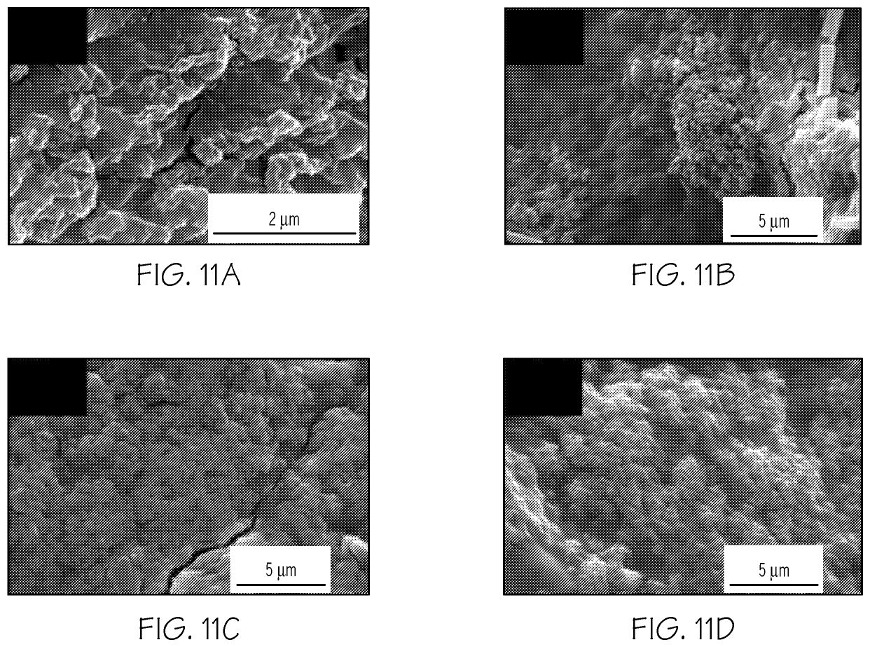

All PVA-MOF gels of Example 5 induced gel formation. Referring now to FIGS. 10A-10D, Examples 5-1, 5-2, 5-3, and 5-4 were analyzed using GIRD) to determine MOF formation. The diffraction pattern of Example 5-1 1010 showed the characteristic peaks of UiO-66-NHh 1020, confirming the formation of UiO-66-NH₂ particles in the gel matrix.

The diffraction pattern of Example 5-2 1030 showed the characteristic peaks of UiO-67 1040, confirming the formation of UiO-67 particles in the gel matrix. The diffraction pattern of Example 5-3 1050 showed the characteristic peaks of NU-901 1060, confirming the formation of NU-901 particles in the gel matrix. The diffraction pattern of Example 5-4 1070 showed the characteristic peaks of MOF-525 1080, confirming the formation of MOF-525 particles in the gel matrix. Additionally, referring now to FIGS. 11A-11D, SEM images of Example 5-1 (FIG. 11A), Example 5-2 (FIG. 11B), Example 5-3 (FIG. 11C), Example 5-4 (FIG. 11D) confirmed the presence of MOF particles in the gels. As exemplified by Examples 5-1 to 5 8, the methods described herein may utilize a variety of carboxylic acid linkers to form polymer-MOF-gels. That is, the methods described herein may be used with various metal salts and carboxylic acid linkers to form polymer-MOF-gels.

### Example 6. Formation of Hydrogels from Polymer-MOF-Gels and Comparative Zr-Oxo-Gels

The gels formed from Comparative Example A-1 (PVA-Zr-oxo-gel), Example 2-1 (2 wt. % PVA-UiO-66-gel), Example 3-5 (3 wt. % PVA-UiO-66-gel), Examples 5-1 (2 wt. % PVA-UiO-66-NH₂-gel), Example 5-2 (2 wt. % PVA-NU-901-gel), Example 5-3 (2 wt. % PVA-UiO-67-gel), and Example 5-4 (2 wt. % PVA-MOF-525-gel) were dialyzed with water to form the hydrogels of Example 6. Specifically, the gels were dialyzed against 3 changes of deionized water through a 3.5 kDa average mass cut-off regenerated cellulose dialysis membrane (Spectra/Por). Each water change was allowed to equilibrate for at least 3 hours. The hydrogels formed from the examples are denoted according to Table 9:

TABLE 9

| | | Wt. % of | | | |
|---|---|---|---|---|---|
| | | PVA in | | | |
| | | product | Average mass | Carboxylic | MOF |
| Example | Gel | mixture | of PVA (kDa) | acid linker | Formed |
| Example 6-1 | Example 2-1 | 2 | 146-186 | H₂BDC | UiO-66 |
| Example 6-2 | Example 5-1 | 2 | 146-186 | H₂ATA | UiO-66- |
| | | | | | NH₂ |
| Example 6-3 | Example 5-2 | 2 | 146-186 | H₄TBSPy | NU-901 |
| Example 6-4 | Example 5-3 | 2 | 146-186 | PBDC | UiO-67 |
| Example 6-5 | Example 5-4 | 2 | 146-186 | TCPP | MOF-525 |
| Comparative | Comparative | 2 | 146-186 | — | — |
| Example 6-A | Example A-1 | | | | |
| Comparative | Comparative | 3 | 146-186 | — | — |
| Example 6-B | Example A-1 | | | | |

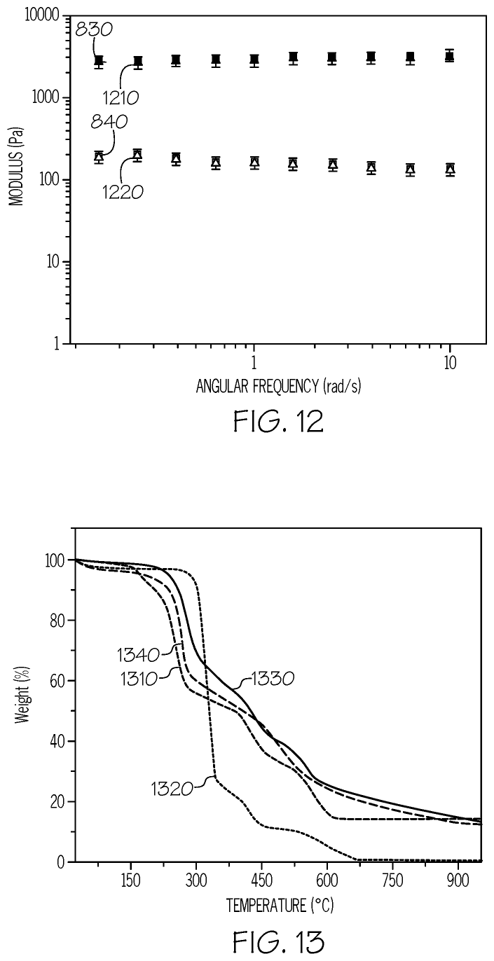

The gel mechanics of hydrogels formed by exchanging the DMSO solvent for water in Example 2-1 (2 wt. % PVA-UiO-66-gel) and Comparative Example A-1 (2 wt. % Zr-oxo-gel) to yield Example 6-1 and Comparative Example 6-A, respectively, were analyzed with oscillatory shear rheology. Referring now to FIG. 12, Example 6-1 retained the same G′ 1210 and G″ 1220 relative to Example 2-1 G′ 830 and G″ 840. On the contrary, Comparative Example A-1 had a G′ of 1.6 kPa at 1 Hz in DMSO and reduced to 0.9 kPa at 1 Hz after dialyzing with water (Comparative Example 6-A), indicating loss of gel stiffness of the PVA-Zr-oxo gel. While not wishing to be bound by theory, it is believed this loss in stiffness of the PVA-Zr-oxo gel may be attributed to water molecules competitively binding to the Zr-oxo clusters instead of the PVA polymers, which may remove at least a portion of the Zr-oxo clusters from the gel during the hydrogel formation. The reduced G′ of the comparative hydrogel (Comparative Example 6-A) in comparison to the comparative gel (Comparative Example A-1) demonstrated reduced gel stiffness, likely due to the reduction of the Zr-oxo cluster content in the PVA-Zr-oxo hydrogel (Comparative Example 6-A) in comparison to the PVA-Zr-oxo gel in DMSO (Comparative Example A-1). In contrast, the G′ of PVA-UiO-66 hydrogel (Example 6-1) remained the same compared to the G′ of PVA-UiO-66 gel (Example 2-1), which indicated a similar stiffness in water despite the competition of water for binding Zr-oxo clusters. Referring now to FIG. 13, the TGA spectra of Comparative Example A 1 1310, Comparative Example 6-A 1320, Example 2-1 1330, and Example 6-1 1340 corroborated the loss of Zr-oxo cluster content after forming the comparative hydrogel. On the contrary, the PVA-UiO-66-gel (Example 2-1) and PVA-UiO-66-hydrogel (Example 6-1) did not demonstrate loss of material upon formation of the hydrogel. Thus, while not wishing to be bound by theory, it is believed that the PVA of Examples 2-1 and 6-1 were physically entrapped within the MOF, thereby reinforcing the gel network.

### Example 7. Small Molecule Loading Using Polymer-MOF-Hydrogels and Comparative Zr-Oxo-Hydrogels

Methylene blue (MB) was loaded into hydrogels to assess small molecule loading capacities of the polymer-MOF-hydrogels, as described in “Loading experiments” of the test methods. Hydrogels were prepared as described in Example 6, but the amount of PVA in the gels was increased to 3 wt. %. The hydrogels formed are denoted according to Table 10:

TABLE 10

| | | Wt. % of | | | |
|---|---|---|---|---|---|
| | | PVA in | | | |
| | | product | Average mass | Carboxylic | MOF |
| Example | Gel | mixture | of PVA (kDa) | acid linker | Formed |
| Example 7-1 | Example 3-5 | 3 | 146-186 | H₂BDC | UiO-66 |
| Example 7-2 | Example 5-5 | 3 | 146-186 | H₂ATA | UiO-66- |
| | | | | | NH₂ |
| Example 7-3 | Example 5-6 | 3 | 146-186 | H₄TBSPy | NU-901 |
| Example 7-4 | Example 5-7 | 3 | 146-186 | PBDC | UiO-67 |
| Example 7-5 | Example 5-8 | 3 | 146-186 | TCPP | MOF-525 |
| Comparative | Comparative | 3 | 146-186 | — | — |
| Example 7-A | Example A-1 | | | | |

Additionally, a PVA-UiO-66 physical mixture (polymer added to preformed MOF) was made according to Comparative Example B-1, but the PVA wt. % was increased to 3 wt. % and is denoted as Comparative Example 7-B. UiO-66 MOF powder that did not include any polymer was also used as a control and is denoted as Comparative Example 7-C.

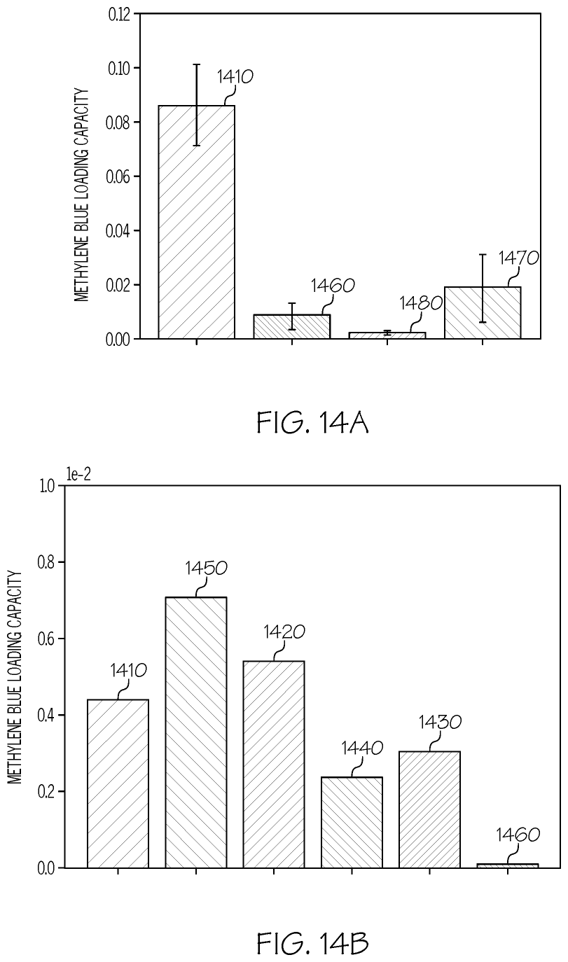

The PVA-UiO-66 hydrogels of Example 7-1 through 7-5, PVA-Zr-oxo hydrogel of Comparative Example 7-A, PVA-UiO-66 physical mixture of Comparative Example 7-B, and the UiO-66 MOF powder of Comparative Example 7-C were immersed in a 50 mg/mL aqueous solution of MB. To keep the relative amount of material (sorbent) exposed to MB constant across all examples, each sorbent was immersed at a concentration of 4 mg of sorbent per 1 mL of MB solution. The absorbance of MB in the solution was monitored at 660 nm. As MB portioned into the sorbent, the absorbance of MB in the solution decreased. The absorbance decrease of the solution at 660 nm was tracked over 7 days to monitor the uptake of MB, relative to the initial concentration of MB in the solution. Referring now to FIG. 14A, the MB loading capacity of the PVA-Zr-oxo hydrogel (Comparative Example 7-A) 1460 was an order of magnitude lower than the PVA-UiO-66 hydrogel 1410, which suggests that the majority of the sorptive capability of PVA-UiO-66 hydrogels was due to the presence of MOF. The MB loading capacity of the PVA-UiO-66 physical mixture (Comparative Example 7-B) 1470 was ˜4 times lower than the PVA-UiO-66 hydrogel (Example 7-1) 1410, showing that the inclusion of the polymer during UiO-66 formation increased sorptive capacity. Surprisingly, despite containing 100 wt % UiO-66, the MB loading capacity of the UiO-66 MOF powder (Comparative Example 7-C) 1480 was ˜40 times lower than the PVA-UiO-66 hydrogel 1410. While not wishing to be bound by theory, it is believed that the increased crystallinity of Example 7-1 relative to Comparative Example 7-C increased the loading capacity by increasing an amount of MB that may be trapped within the MOFs. Specifically, the coherence length of PVA-UiO-66-gel and the UiO-66 MOF powder was 50.1 nanometers, and 25.1 nanometers, respectively, as determined using the Scherrer equation. This increased coherence length indicated increased crystallinity in the polymer-MOF-gel in comparison to the MOF alone.

The MB loading was also evaluated by measuring the weight of MB loaded per weight of hydrated gel. Referring to FIG. 14B, Example 7-1 1410, Example 7-2 1420, Example 7-3 1430, Example 7-4 1440, and Example 7-5 1450 were able to sorb MB with loading capacities between 0.2 and 0.8 g MB per weight of hydrated gel, demonstrating sorptive capability using polymer-MOF hydrogels described herein. In comparison, the PVA-Zr-oxo hydrogel (Comparative Example 7-A) loaded a negligible amount of MB 1460.

### Example 8. Small Molecule Release Using Polymer-MOF-Hydrogels and Comparative Zr-Oxo-Gels

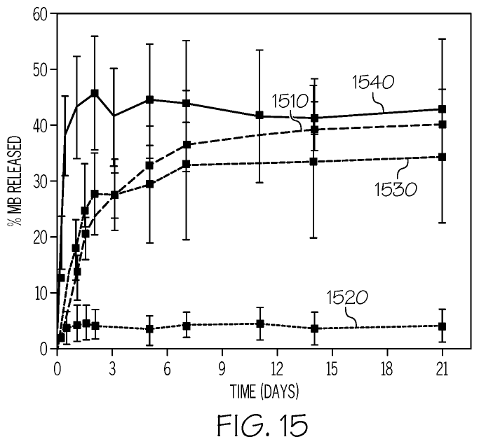

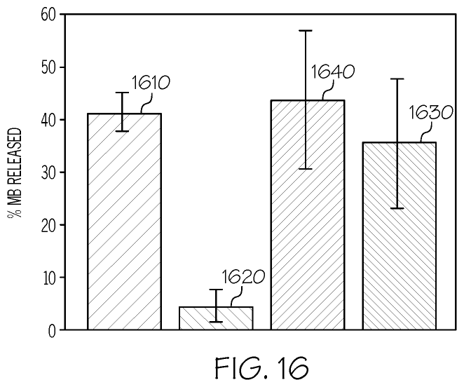

The release of MB from hydrogels loaded in Example 7 was evaluated. Referring now to FIG. 15, the release of MB from Example 7-1 (PVA-UiO-66 hydrogel) 1510, Comparative Example 7-A (PVA-Zr-oxo hydrogel) 1520, Comparative Example 7-B (PVA-UiO-66 physical mixture) 1530, and Comparative Example 7-C(UiO-66 MOF powder) 1540 was monitored over time, as described in “Release experiments” of the test methods. FIG. 16 shows the % of MB released for Example 7-1 1610, Comparative Example 7-A 1620, Comparative Example 7-B 1630, and Comparative Example 7-C(UiO-66 MOF powder) 1640 after 21 days. While both Example 7-1 (PVA-UiO-66-hydrogel) and Comparative Example 7-C(UiO-66 MOF powder) released a similar percentage of the loaded MB, Example 7-1 demonstrated release over 21 days, whereas Comparative Example 7-C demonstrated release over just 2 days. Comparative Example 7-A released an order of magnitude less of the loaded MB in comparison to Example 7-1, demonstrating the MOF plays an important role in facilitating small molecule release from the polymer-MOF-gel. Slower drug release over a longer period of time may be advantageous in certain therapeutic applications. Thus, the polymer-MOF-hydrogels, as described herein, may provide improved therapeutic outcomes compared to conventional systems.

### Example 9. Peptide Loading Using Polymer-MOF-Hydrogels and Comparative Zr-Oxo-Hydrogels

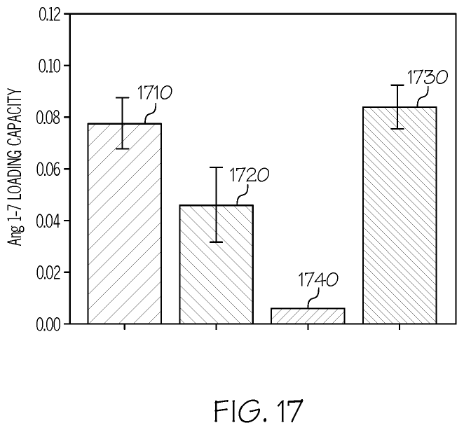

A polymer-MOF hydrogel was used to load larger therapeutic peptides. Specifically, Angiotensin 1-7 (Ang 1-7) was loaded into a 3 wt. % PVA-MOF-525 polymer-MOF hydrogel (formed according to Example 6-5, but had an increased amount of PVA), denoted as Example 9-1. Ang 1-7 was also loaded into comparative examples. The comparative examples included the 3 wt. % PVA-Zr-oxo hydrogel (Comparative Example 7-A), denoted as Comparative Example 9-A, a 3 wt. % PVA-MOF-525 physical mixture (formed according to Comparative Example B-1 but had an increased amount of PVA, used TCPP as the carboxylic acid linker, and was dialyzed according to Example 6), denoted as Comparative Example 9-B, and a MOF-525 powder, denoted as Comparative Example 9-C. The sorbent (Example 9-1, or Comparative Example 9-A, 9-B, or 9-C) was added to a 150 μM aqueous Ang 1-7 solution at 20 mg per 1 mL of Ang 1-7 solution. The UV absorbance of the outer solution at 280 nm was monitored over 7 days. FIG. 17, shows the loading capacity of Example 9-1 1710, Comparative Examples 9-A 1720, 9-B 1730, and 9-C 1740. Example 9-1 demonstrated higher Ang 1-7 loading capacity than both Comparative Example 9-A (PVA-Zr-oxo hydrogel) and Comparative Example 9-C(MOF-525 powder). As exemplified by Comparative Examples 9-A to 9-C and Example 9-1, the polymer and the MOF are important for increasing sorptive capabilities of the hydrogels. Although, Comparative Example 9-B (PVA-MOF-525 physical mixture) did load a similar amount of Ang 1-7 as Example 9-1, Comparative Example 9-B did not produce a gel as determined by the inversion test. That is, the polymer-MOF-gels as described herein may provide both high drug loading and gel strength in comparison to conventional systems.

These results demonstrate that a given amount of a polymer with a certain side chain chemistry and chain length may be selected to form a polymer-MOF-gel or hydrogels as described herein, based on desired properties, such as but not limited to gel strength, pore size to accommodate loading of specific payloads, or payload release kinetics, among others. It will be apparent to persons of ordinary skill in the art that various modifications and variations can be made without departing from the scope disclosed herein. Since modifications, combinations, sub-combinations, and variations of the disclosed embodiments, which incorporate the substance disclosed herein, may occur to persons of ordinary skill in the art, the scope disclosed herein should be construed to include everything within the scope of the appended claims and their equivalents.

For the purposes of defining the present technology, the transitional phrase “consisting of” may be introduced in the claims as a closed preamble term limiting the scope of the claims to the recited components or steps and any naturally occurring impurities. For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter. The transitional phrases “consisting of” and “consisting essentially of” may be interpreted to be subsets of the open-ended transitional phrases, such as “comprising” and “including,” such that any use of an open ended phrase to introduce a recitation of a series of elements, components, materials, or steps should be interpreted to also disclose recitation of the series of elements, components, materials, or steps using the closed terms “consisting of” and “consisting essentially of.” For example, the recitation of a composition “comprising” components A, B, and C should be interpreted as also disclosing a composition “consisting of” components A, B, and C as well as a composition “consisting essentially of” components A, B, and C. Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

As used in the Specification and appended Claims, the singular forms “a”, “an”, and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced.

It should be understood that any two quantitative values assigned to a property may constitute a range of that property, and all combinations of ranges formed from all stated quantitative values of a given property are contemplated in this disclosure. The subject matter disclosed herein has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

1. A method of making a polymer-metal organic framework-gel (polymer-MOF-gel), the method comprising:
forming a metal solution comprising a metal salt, an acid, and a first solvent; and
forming a product mixture comprising the metal solution, a polymer, and a carboxylic acid linker to produce the polymer-MOF-gel.

2. The method of claim 1, wherein a MOF of the polymer-MOF-gel and the polymer-MOF-gel are formed simultaneously.

3. The method of claim 1, wherein the carboxylic acid linker does not contact the metal solution in the absence of the polymer.

4. The method of claim 1, further comprising forming a polymer mixture comprising the polymer and a second solvent before forming the product mixture, wherein the product mixture comprises the metal solution, the polymer mixture, and the carboxylic acid linker.

5. The method of claim 1, wherein at least a portion of the polymer of the polymer-MOF-gel is within pores of a MOF of the polymer-MOF-gel.

6. The method of claim 1, wherein the polymer comprises side groups, the side groups comprising polar groups, lone pair electron groups, pi-stacking groups, or combinations thereof.

7. The method of claim 6, wherein the polar groups comprise carboxyl groups, hydroxyl groups, amine groups, or combinations thereof.

8. The method of claim 6, wherein the side groups comprise from 0% to 50% of the carboxyl groups, based on a total number of the side groups.

9. The method of claim 1, wherein the polymer comprises polyvinyl alcohol, polyethylene glycol, polyacrylic acid, poly(acrylamide-co-acrylic acid), polystyrene, polyvinylidene fluoride, polystyrene sulfonate, poly(3,4-ethylenedioxythiophene), poly[2,5-bis(3-tetradecylthiophen-2-yl)thieno[3,2-b]thiophene], poly[2,5-bis(3-dodecylthiophen-2-yl)thieno[3,2-b]thiophene], poly[2,5-bis(3-hexadecylthiophen-2-yl)thieno[3,2-b]thiophene], poly[2,5-bis(3-octadecylthiophen-2-yl)thieno[3,2-b]thiophene], polythiophene, polytetrafluoroethylene, poly(perfluoro-3,6-dioxa-4-methyl-7-octene-sulfonic acid), or combinations thereof.

10. (canceled)

11. The method of claim 1, wherein the polymer has an average mass from 10 kilodaltons (kDa) to 500 kDa.

12. The method of claim 1, wherein the polymer comprises polyethylene glycol having an average mass greater than or equal to 10 kilodaltons and the product mixture comprises greater than or equal to 1 weight percent (wt %) of the polymer, based on a total weight of the product mixture.

13. The method of claim 1, wherein the polymer comprises poly(acrylamide-co-acrylic acid), the poly(acrylamide-co-acrylic acid) comprising a molar ratio of acrylamide to acrylic acid from 9:1: to 1:1.

14. The method of claim 1, wherein the product mixture comprises greater than or equal to 0.5 wt % and less than or equal to 20 wt % of the polymer, based on a total weight of the product mixture.

15. The method of claim 1, wherein the metal salt is selected from the group consisting of a zirconium salt, a zinc salt, a copper salt, an aluminum salt, an iron salt, a titanium salt, a magnesium salt, a hafnium salt, a cobalt salt, and combinations thereof.

16-20. (canceled)

21. A polymer-metal organic framework-gel (polymer-MOF-gel), the polymer-MOF-gel comprising:
a polymer; and
a metal organic framework (MOF) having pores,
wherein at least a portion of the polymer is entrapped in the pores of the MOF.

22. The polymer-MOF-gel of claim 21, wherein the polymer comprises side groups, the side groups comprising polar groups, carboxyl groups, lone pair electron groups, pi-stacking groups, or combinations thereof.

23. The polymer-MOF-gel of claim 22, wherein the polar groups comprise carboxyl groups, hydroxyl groups, amine groups, or combinations thereof.

24. The polymer-MOF-gel of claim 22, wherein the side groups comprise from 0% to 50% of the carboxyl groups, based on a total number of the side groups.

25. The polymer-MOF-gel of claim 21, wherein the polymer has an average mass from 10 kilodaltons (kDa) to 500 kDa.

26. The polymer-MOF-gel of claim 21, wherein the polymer-MOF-gel comprises polyvinyl alcohol, polyethylene glycol, polyacrylic acid, poly(acrylamide-co-acrylic acid), polystyrene, polyvinylidene fluoride, polystyrene sulfonate, poly(3,4-ethylenedioxythiophene), poly[2,5-bis(3-tetradecylthiophen-2-yl)thieno[3,2-b]thiophene], poly[2,5-bis(3-dodecylthiophen-2-yl)thieno[3,2-b]thiophene], poly[2,5-bis(3-hexadecylthiophen-2-yl)thieno[3,2-b]thiophene], poly[2,5-bis(3-octadecylthiophen-2-yl)thieno[3,2-b]thiophene], polythiophene, polytetrafluoroethylene, poly(perfluoro-3,6-dioxa-4-methyl-7-octene-sulfonic acid), or combinations thereof.

27-32. (canceled)
